(19) United States
(12) Patent Application Publication
(10) Pub. No.: US 2006/0249715 A1
(43) Pub. Date: Nov. 9, 2006

(54) METHOD FOR REDUCING FLAME SPREAD

(76) Inventors: David Gayle Salyer, Kingsport, TN (US); Marc Alan Strand, Kingsport, TN (US); Douglas Stephens McWilliams, Kingsport, TN (US); Marcus David Shelby, Kingsport, TN (US); John Edward Christopher Willham, Sandy, UT (US); Michael Eugene Donelson, Gray, TN (US); Eric Douglas Middlemas, Johnson City, TN (US)

Correspondence Address: ERIC D. MIDDLEMAS;EASTMAN CHEMICAL COMPANY, P. O. BOX 511, KINGSPORT, TN, 37662-5075, US

(21) Appl. No.: 11/278,711

(22) Filed: Apr. 5, 2006

Related U.S. Application Data
(60) Provisional application No. 60/594,492, filed on Apr. 12, 2005.

(51) Int. Cl. C09K 21/00

(52) U.S. Cl. 252/601

(57) ABSTRACT

Disclosed is a method to reduce flame spread within a room by attaching an interior finish compising at least 80 weight percent of a polymer composition to a ceiling, one or more walls, or combination thereof, wherein the interior finish partially or completely detaches from the wall or ceiling upon exposure to the heat of a flame. The polymer composition has certain properties of crystallization half-time, heat release capacity, and char generation and can comprise one or more polymers. The interior finish may detach or partially detach from the ceiling or wall as a result its thermal behavior when exposed to heat or as a result of softening or melting of fasteners. The spacing of the fasteners of the interior finish is dependent on the physical properties of the polymer.

### CROSS REFERENCES TO RELATED APPLICATIONS

This application claims the benefit under 35 U.S.C. §119(e) of U.S. Provisional Application Ser. No. 60/594,492, filed Apr. 12, 2005, and which is incorporated by reference in its entirety.

### FIELD OF THE INVENTION

The present invention pertains to reducing flame spread within a room. More specifically, the present invention pertains to reducing flame spread along interior finishes within a room.

### BACKGROUND OF THE INVENTION

Materials for building and construction applications are subject to flammability requirements. Many flammability tests for building materials include specifications related to the flame spread and smoke generation, that is, the manner in which material reacts to an existing fire in a structure. In order to pass most flammability requirements, the building material should not appreciably spread the flame to any other parts of the room and should not add appreciably to total heat or smoke generated in the fire.

Manufacturers of building materials such as, for example, interior finishes, meet these flammability requirements using a variety of methods. The simplest means is to use nonflammable material such as, for example, glass, stone, concrete, metal, or brick to manufacture their products. These materials, however, often are extremely heavy, can be difficult to work with, and do not offer the design versatility that is needed for many modern buildings. Wood and polymeric materials are versatile and can be manufactured into a wide range of product designs and functions, but most of these materials do not meet the flammibility requirements. The flammability of these materials frequently is controlled through the addition of flame retardants. The use of flame retardants, however, is expensive and many flame retardants can produce toxic fumes during a building fire. The incorporation of flame retardants, especially in large amounts, also can reduce the toughness and heat deflection temperature of some polymers. One exception is poly(vinyl chloride), which is inherently nonflammable and is widely used for interior finish applications. Poly(vinyl chloride), however, also can release toxic hydrogen chloride when subjected to flames and is environmentally tenacious. It would be desirable, therefore, to provide a method to reduce flame spread and smoke generation for interior finishes manufactured from a combustable substrates which does not require the use of flame retardants or poly(vinyl chloride). Such a method would enable the use of many combustable materials for the manufacture of interior finishes that otherwise could not be used because of poor flammability properties. This method would have widespread utility in the building and construction industry.

### SUMMARY OF THE INVENTION

It has been found that flame spread along an interior finish containing polymeric materials having certain properties can be reduced by attaching the interior finish in a manner which allows the interior finish to at least partially detach from a wall or ceiling upon exposure to the heat of a flame. Thus, the present invention provides a method for reducing flame spread, comprising: attaching at least one interior finish to a ceiling, one or more walls, or combination thereof, of a room, the interior finish comprising a film, sheet, or profile comprising at least 80 weight percent, based on the total weight of the interior finish, of a polymer composition having a crystallization half-time of at least 5 minutes, a heat release capacity of about 400 J/g ° K or less, and a char generation of 20% or less, and having a total area of at least 10% of the total area of the ceilings and walls of the room, wherein the interior finish partially or completely detaches from the walls or ceiling after exposure for 5 minutes or less to the heat of a 40 kW flame as set forth by National Fire Protection Agency Standard NFPA 286.

We have discovered that interior finishes based on polymer compositions having certain properties of crystallization half-time, heat release capacity, and char generation will have reduced flame spread if the interior finish is attached to a wall or ceiling in a manner that will allow at least a portion of the interior finish to detach from the wall during exposure to a flame. During exposure to the heat of a flame, the interior finish can completely or partially detach from the wall such that its exposure to the heat of the flame is reduced. Accordingly, flame spread along the interior finish and smoke generation also are reduced.

The interior finish may comprise a sheet, film, profile, fiber, fabric, or prefabricated panel and may include one or more layers. For example, the interior finish may be a sheet, film, or laminated structure prepared by extrusion, calendering, thermoforming, and the like. The interior finish can comprise about 80 to 100 weight percent, based on the total weight of the interior finish, of a polymer composition which, in turn, may include, but is not limited to, polyesters, polyamides, polycarbonates, polypropylenes, polyethylenes, polyacrylates, cellulosics, poly(methylmethacrylates), copolymers thereof, and combinations thereof. In one embodiment of the invention, for example, the polymer composition comprises a polyester.

The interior finish may partially or completely detach from the wall or ceiling upon exposure to the heat of a 40 kW to a 160 kW flame as set forth by National Fire Protection Agency Standard NFPA 286. To minimize flame spread, however, it is preferable that the interior finish partially or completely deattach after exposure for 5 minutes or less to the heat of a 40 kW flame. For example, the interior finish may detach by sagging, curling, peeling, falling away, shrinking, or foaming. In one aspect of the invention, for example, 2 or more fasteners which soften or melt at a temperature of about 70° C. to about 250° C. may be used and which releases the interior finish from the wall or ceiling on exposure to the heat of a flame.

In one embodiment of our novel method, we have found that detachment of the interior finish from a wall or ceiling with the reduction in flame spread depends upon the properties of the polymer composition and the spacing between the fasteners for the interior finish to the wall. The spacing between the fasteners, in turn, depends on the thickness of the film and the glass transition temperature (abbreviated hereinafter as “Tg”) of the polymer. Thus, another aspect of the invention is a method for reducing flame spread, comprising: attaching at least one interior finish to a ceiling, one or more walls, or combination thereof, of a room with 2 or more fasteners, the interior finish having a total area of at least 10% of the total area of the ceiling and walls of the room and comprising a film, sheet, or profile comprising at least 80 weight percent, based on the total weight of the interior finish, of a polymer composition having a crystallization half-time of at least 5 minutes, a heat release capacity of about 400 J/g ° K or less, and a char generation of 20% or less, and the fasteners being separated by an average spacing, L, that is equal to or greater than a minimum distance, Lc, wherein L and Lc are defined by the following formulas:

$$L = \sqrt{\frac{Area}{N - 2 \sqrt{N} + 1}}$$

wherein
L is the average spacing in meters,
N is the number of the fasteners, and
Area is the area of the interior finish in square meters; and

$${L}_{C} = 2.69 \times {{10}^{- 7} [ exp ( \frac{- 19892}{75 exp ( - 308 \text{/} δ ) + 200 exp ( - 205 \text{/} δ ) + Tg - 653} ) ]}^{1 / 3}$$

wherein
Lc is the minimum distance in meters,
δ is the thickness in mils of the interior finish, and
Tg is the glass transition temperature of the polymer composition in ° C.
   The polymer composition may comprise one or more polyesters, polyamides, polycarbonates, polypropylenes, polyethylenes, polyacrylates, cellulosics, poly(methylmethacrylate)s, copolymers thereof, and combinations therof. For example, the polymer composition may comprise a polyester comprising at least 80 percent, based on the total diacid residues, of one of more residues of terephthalic acid, naphthalenedicarboxylic acid, 1,4-cyclohexanedicarboxylic acid, and isophthalic acid; and about 10 to 100 mole percent, based on the total diol residues, of the residues of one or more diols selected from the group consisting of 1,4-cyclohexanedimethanol; neopentyl glycol; 2,2,4,4-tetra-methyl-1,3-cyclobutanediol, and ethylene glycol. The interior finish also may comprise a heat shrinkable sheet, film, fiber, or fabric to enhance detachment from a wall or ceiling upon exposure to heat.

The interior finish also may be set off at a distance of about 0.5 cm to about 20 cm from the ceiling or wall. Other examples of distances are about 1 cm to about 20 cm, and about 1.5 cm to about 20 cm. In another embodiment of the invention, therefore, is a method for reducing flame spread, comprising: attaching at least one interior finish to a ceiling, one or more walls, or combination thereof, of a room with 2 or more fasteners, wherein at least a portion of the inside surface of the interior finish is positioned at about 0.5 cm to about 20 cm from the surface of the ceiling or walls, the interior finish having a total area of at least 10% of the total area of the ceilings and walls and comprising a film, sheet, or profile comprising at least 80 weight percent, based on the total weight of the interior finish, of a polymer composition having a crystallization half-time of at least 5 minutes, a heat release capacity of 400 J/g ° K or less, and a char generation of 20% or less, and the fasteners being separated by an average spacing, L, that is equal to or greater than a minimum distance, Lc, wherein L and Lc are defined by the following formulas:

$$L = \sqrt{\frac{Area}{N - 2 \sqrt{N} + 1}}$$

wherein
L is the average spacing in meters,
N is the number of the fasteners, and
Area is the area of the interior finish in square meters; and

$${L}_{C} = 2.69 \times {{10}^{- 7} [ exp ( \frac{- 19892}{75 exp ( - 308 \text{/} δ ) + 200 exp ( - 205 \text{/} δ ) + Tg - 653} ) ]}^{1 / 3}$$

wherein
Lc is the minimum distance in meters,
δ is ½ of the thickness in mils of the interior finish, and
Tg is the glass transition temperature of the polymer composition in ° C.
   When the interior finish is offset as described above, the finish is exposed to heat from the interior and exterior surface of the finish, which reduces the effect of the thickness of the interior finish on the spacing of the attachment points by about ½.

Another aspect of our invention is method for attaching an interior finish to a ceiling or wall with a fastener that softens or melts at elevated temperatures. Thus, the instant invention also provides a method for reducing flame spread, comprising: attaching at least one interior finish to a ceiling, one or more walls, or combination thereof, of a room, with 2 or more fasteners which soften or melt at a temperature of of about 70° C. to about 250° C., the interior finish comprising at least 50 weight percent of combustable substrate and having a total area of at least 10% of the total area of the walls and ceilings. In this embodiment of the invention, the interior finish can include at least 50 weight percent, based on the total weight of the interior finish, of any combustable substrate such as, for example, wood or a polymer. During a fire, as the temperature of the room increases to about 70° C. to about 250° C., the fasteners soften or melt and allow the interior finish to partially or completely detach from the ceiling or wall.

### BRIEF DESCRIPTION OF THE DRAWINGS

FIG. 1 is a schematic drawing showing the approximate layout of attachment points for the perimeter and rigid mounting patterns described in the Examples section of the application.

### DETAILED DESCRIPTION

Flame spread along an interior finish containing combustable materials can be reduced by attaching the interior finish in a manner which allows the interior finish to partially or completely detach from a wall, ceiling, or a combination thereof upon exposure to the heat of a flame. Thus, in a general embodiment, the present invention is for a method for reducing flame spread, comprising: attaching at least one interior finish to a ceiling, one or more walls, or combination thereof, of a room, the interior finish comprising a film, sheet, or profile comprising at least 80 weight percent, based on the total weight of the interior finish, of a polymer composition having a crystallization half-time of at least 5 minutes, a heat release capacity of about 400 J/g ° K or less, and a char generation of 20% or less, and having a total area of at least 10% of the total area of the ceilings and walls of the room, wherein the interior finish partially or completely detaches from the walls or ceiling after exposure for 5 minutes or less to the heat of a 40 kW flame as set forth by National Fire Protection Agency Standard NFPA 286.

We have found that interior finishes based on polymer compositions having certain properties of crystallization half-time, heat release capacity, and char generation will have reduced flame spread if that interior finish is attached to a wall or ceiling in a manner that will allow at least a portion of the interior finish to detach from the wall during exposure to a flame. By at least partially detaching from the wall or ceiling, the interior finish reduces its exposure to the heat of the flame and, accordingly, its participation in the burning process.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C₁ to C₅ hydrocarbons”, is intended to specifically include and disclose C₁ and C₅ hydrocarbons as well as C₂, C₃, and C₄ hydrocarbons.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

As used in the specification and the appended claims, the singular forms “a,” “an” and “the” include their plural referents unless the context clearly dictates otherwise. For example, references to a “polymer,” “polymer composition”, or an “interior finish,” is intended to include a plurality of polymers, polymer compositions, or interior finishes. References to a composition containing or including “an” ingredient or “a” polymer is intended to include other ingredients or other polymers, respectively, in addition to the one named.

By “comprising” or “containing” or “including”, we mean that at least the named compound, element, particle, or method step, etc., is present in the composition or article or method, but does not exclude the presence of other compounds, catalysts, materials, particles, method steps, etc, even if the other such compounds, material, particles, method steps, etc., have the same function as what is named, unless expressly excluded in the claims.

It is also to be understood that the mention of one or more method steps does not preclude the presence of additional method steps before or after the combined recited steps or intervening method steps between those steps expressly identified. Moreover, the lettering of process steps or ingredients is a convenient means for identifying discrete activities or ingredients and the recited lettering can be arranged in any sequence, unless otherwise indicated.

Our invention relates to a method for reducing flame spread and/or smoke generation within a room by attaching an interior finish to a ceiling, one or more walls, or combination thereof, of a room wherein the interior finish at least partially detaches from the wall or ceiling upon exposure for 5 minutes or less to the heat of a 40 kW flame. Unless otherwise indicated, the term “attached”, as used herein, is understood to have its commonly understood meaning, that is, the interior finish is fastened to the wall or ceiling such that the inside surface of the interior finish is substantially in continuous contact with the outside surface of the wall or ceiling. The interior finish, typically, is attached to the ceiling or wall using 2 or more fasteners, but may include up to 10,000 fasteners, depending on the size of the interior finish. In some aspects of the invention, however, the interior finish may be attached such that the inside surface of the interior finish is set off from the outside surface of the wall or ceiling at a distance of about 0.5 cm to about 20 cm. The term “fastener”, as used herein, refers to any means of joining, attaching, or affixing the interior finish to a ceiling or wall that is known to persons of ordinary skill in the art such as, for example, screws, nails, bolts, rivets, clasps, brackets, adhesives, clamps, staples, tape, and combinations thereof. The term “interior finish”, as used herein, means any material used to cover the interior framed areas, or materials of walls and ceilings. Typically, interior finishes are attached to walls or ceilings in discrete panels, sheet, strips, or profies. The dimensions of the interior finish are not important for the method of the invention; however, for flammability testing, 4 foot by 8 foot sheets are typically used. Examples of interior finishes include, but are not limited to, sheet, film, profiles, fibers, fabric, wainscoting, film and sheet laminated to fabric, wall covering, laminates of one or more polymers, and prefabricated panels comprising any of the above. The term “profile”, as used herein, means an object with an cross sectional area, extruded continously through a forming die. Examples of profiled materials include corner guards, pricing channels, tubing, pipe, and the like. The interior finish typically will comprise 1 to 7 layers. In addition, any of the above finishes may further comprise a coating such as, for example, a paint or sealant.

The interior finishes and the polymer compositions of the present invention typically comprise combustible materials. By the term “combustible”, as used herein, it is understood that the material is capable of supporting a flame in the presence of air. For example, the combustible material may be wood, one or more polymers, or a combination of thereof. The term “flame spread”, as used herein, is understood to have its plain meaning as would be understood by persons of ordinary skill in the art, that is, the propagation of a flame from its ignition source across the surface of a solid or liquid, or through the volume of a gaseous mixture. For the present invention, flame spread is intended to mean the propagation of a flame across the surface of an interior finish. Flame spread may be determined by flammability tests well known to persons skilled in the art such as, for example, by National Fire Protection Agency Standard NFPA 286.

The method of the invention is directed to one or more interior finishes which have a total area of at least 10% of the total area of the ceiling and walls of a room. The term “area” is understood to mean “surface area”. For example, if the total area of ceiling and walls of a room was 800 square feet, the interior finishes of the present invention would have a total surface area of at least 80 square feet. The term “room”, as used herein, has its plain meaning of an area within a building that is enclosed by a floor, walls, and a ceiling. The terms “ceiling or walls”, as used herein, is understood to mean the covered enclosures of a room as well as any framing that encloses a room, whether covered or not. Our method is understood to encompass attaching an interior finish to one or more walls, to a ceiling, or to a combination of one or more walls and the ceiling. Other examples of the total area of the interior finishes of the instant invention are at least 20%, at least 30%, at least 40%, at least 50%, at least 70%, at least 80%, at least 90%, and 100% of the total area of the ceiling and walls of a room.

The interior finish is attached to a one or more walls, ceiling, or combination thereof in a manner that permits the interior finish to at least partially detach from the wall or ceiling after 5 minutes or less exposure to the heat of a 40 kW flame as set forth by National Fire Protection Agency Standard NFPA 286 (referred to herein also as “NFPA 286 test”). The interior finish, typically, is attached to the ceiling or wall using 2 or more fasteners. The detachment also can occur with the heat from various flame energy ranges as defined by flammability standard tests in countries other than the United States. Examples of other flammability tests are EN 13823 (United Kingdom) and ISO 9705-2003. The term “detach”, as used herein, means that the interior finish panel, on exposure to a 40 kW flame as set forth in the NFPA 286 test, is partially or completely displaced from the surface of the ceiling or wall such that the underlying surface to the ceiling or wall is no longer covered by the interior finish and the exposure of the interior finish to the flame is reduced. The term “partially detach”, as used in herein, means that about 0.5 to about 99 area percent of the interior finish panel, on exposure to a 40 kW flame as set forth in the NFPA 286 test, is displaced from the surface of the ceiling or wall. The interior finish may separate by falling away from or off a wall or ceiling, or by sagging, pulling away, curling, peeling, shrinking, or foaming. For example, the interior finish may fall off the wall completely upon exposure to the heat of a flame. In another example, a portion of the interior finish may curl or peel away from the ceiling or wall. Typically, all or a portion of the detached interior finish will move out of the plane of the ceiling or wall. Once the interior finish detaches from the wall, its exposure to the heat of the flame is reduced and the possibility of ignition of the interior finish from the heat of the flame is also diminished. Thus, the total exposure of the interior finish to the heat of the flame prior to the detachment can be greater than the total exposure to heat after detachment. In addition, if the detached portion of the interior finish does ignite, flame spread to the remaining attached interior finish is reduced because the remaining attached interior finish is out of the path of the flame.

The interior finish of the method of the present invention comprises at least 80 weight percent of a polymer composition, based on the total weight of the interior finish. The polymer compositions typically are thermoplastic, meaning that the compositions soften when heated and become firm on cooling. Other examples of polymer composition weight percents within the interior finish are at least 85 weight percent, at least 90 weight percent, at least at least 95 weight percent, at least 99 weight percent, and 100 weight percent. The polymer composition of the invention can comprise at least one polymer. Representative examples of polymers include, but are not limited to, polyester, polyamide, polycarbonate, polypropylene, polyethylene, polyacrylate, cellulosic, poly(methylmethacrylate), copolymers thereof, and combinations thereof. A combination of one or more polymers may include, for example, laminates comprising at least 2 layers of the same or different polymers in each layer or miscible and immiscible blends of 2 or more polymers. For example, the interior finish may comprise polymer composition comprising a single polyester. In another example, the polymer composition may comprise a combination of 2 or more polymers as a miscible or immiscible blend. In still another example, the polymer composition may comprise a combination of 2 or more polymers present in separate layers laminated to form in a sheet or prefabricated panel.

The detachment of the interior finish from a wall or ceiling and/or the comcomitant reduction in flame spread can depend upon the properties of the polymer composition. Certain properties of the polymer composition inhibit detachment of the interior finish from the wall or ceiling such that flame spread is not substantially reduced. These inhibiting properties include a high glass transition temperature, a fast crystallization rate, and a high char generation. In addition, polymer compositions that exhibit a high flammability as defined by their heat release capacity also will tend to ignite before the interior finish detaches from the wall.

The polymer composition advantageously has a crystallization half-time of at least 5 minutes to enhance the detachment of the interior finish from the ceiling or wall. The crystallization half-time may be determined from the molten or the glass state using techniques well known to persons of ordinary skill in the art. Polymer compositions with shorter crystallization half-times will tend to crystallize quickly when exposed to the heat of a flame and will not sag, foam, curl, shrink, peel, or fall away sufficiently to reduce exposure to the heat of the flame. These materials, therefore, will tend to ignite rapidly and propagate the flame. Additional examples of crystallization half-times from the molten or the glass state for the polymers of the interior finish include, but are not limited to, at least 10 minutes, at least 100 minutes, and infinity. For example, amorphous polymers typically are considered by persons skilled in the art to have a crystallization half-time of infinity. For the present invention, the determination of crystallization half time for polymers may be from the molten state or the glass state using techniques well known to persons of ordinary skill in the art. For example, the crystallization half time may be measured using a Perkin-Elmer Model DSC-2 differential scanning calorimeter. The crystallization half time is measured from the molten state using the following procedure: a 15.0 mg sample of the polyester is sealed in an aluminum pan and heated to 290° C. at a rate of about 320° C./min for 2 minutes. The sample is then cooled immediately to the predetermined isothermal crystallization temperature at a rate of about 320° C./minute in the presence of helium. The isothermal crystallization temperature is the temperature between the glass transition temperature and the melting temperature that gives the highest rate of crystallization. The isothermal crystallization temperature is described, for example, in Elias, H. Macromolecules, Plenum Press: NY, 1977, p 391. The crystallization half time is determined as the time span from reaching the isothermal crystallization temperature to the point of a crystallization peak on the DSC curve. Crystallization half times from glass state can be measured also using a Perkin-Elmer Model DSC-2 differential scanning calorimeter. A sample of 10.0 mg is sealed in an aluminum pan and heated to 290° C. at a rate of about 320° C./min for 2 minutes. The sample is then quenched on a chilled block which has a temperature blow 0 degree C. After the DSC is cooled to a temperature 30° C. below the glass transition temperature of the sample, the quenched sample was then put back to the cell and heated to the predetermined isothermal crystallization temperature at a rate of about 320° C./min in the presence of helium. The crystallization half time is determined as the time span from reaching the isothermal crystallization temperature to the point of a crystallization peak on the DSC curve as described above.

Crystallization half time can also be determined by Small Angle Laser Light Scattering (SALLS) by measuring the light transmission of a sample via a laser and photo detector as a function of time on a temperature controlled hot stage. This measurement is carried out by exposing the polymers to a temperature above its melting point and then cooling it to the desired test temperature. The sample is then held at the desired temperature by a hot stage while transmission measurements were made as a function of time. Initially, the sample is visually clear with high light transmission and became opaque as the sample crystallized. The crystallization half-time is recorded as the time at which the light transmission was halfway between the initial transmission and the final transmission.

It is also desirable that the polymer of the interior finish have a heat release capacity of 400 J/g ° K or less. As the heat release capacity of a polymer increases, its fuel value and tendency to burn also increases. The heat release capacity of polymeric materials may be calculated using techniques known in the art such as, for example, as described by Waters et al. in “Molar Group Contributions to Polymer Flammability”, Journal of Applied Polymer Science, Vol 87 (2003), pages 548-563. For copolymers, the contribution to heat release capacity for each repeat unit is calculated using the group contribution method and then the heat release capacity for the copolymer is determined as a weighted average based on mole fraction of each repeat unit and the respective molar heat release capacities. For blends and/or polymer laminates, the heat release capacity for each polymer is calculated using the group contribution method and then the total heat release capacity for the blend is approximated as a weighted average based upon the weight fractions and the respective specific heat release capacities. Other representative examples of heat release capacities for the polymer compositions of the invention are 350 J/g ° K or less, and 300 J/g ° K or less.

According to the invention, the polymer composition of the interior finish has a char generation of about 35% or less, typically 20% or less, more typically 15% or less, and most typically, 10% or less. Other examples of char generation are 0 to about 35%, about 0.5 to about 30%, and about We have found unexpectedly that polymers that generate high levels of char, typically greater than about 35%, resist certain modes of detachment from from a ceiling or wall on exposure to the heat from a flame as the char can inhibit the material from curling, peeling, shrinking, or sagging away from the flame source before it ignites. The determination of char generation for polymers is known in the art. For example, weight percent char can be determined using thermal gravimetric analysis (TGA) by measuring the weight of the residual mass after heating a polymer sample from 300 to 600° C. at a scan rate of 20° C. per minute in nitrogen atmosphere using a TA Instruments model 2950 thermal gravimetric analyzer. For blends and laminates, it is preferable to measure the effective char directly using samples representative of the blend/laminate structure. If sample size limitations of many TGA instruments prevent direct measurement, the char value also can be estimated for blends and laminates using the weighted average of the char values for the individual components.

The interior finish can be colored, clear, transparent, or opaque depending on the application and can be manufactured by several different polymer processes such as sheet extrusion, film extrusion, thermoforming, calendering, lamination, and the like. In addition, the polymer compositions can include flame retardants and other additives such as colorants, impact modifiers, antioxidants, and the like. In addition, additives such as impact modifiers, colorants, flame retardants, viscosity modifiers, and the like can be incorporated in a surface layer or other layer to improve properties through the process of coextrusion or lamination.

The capability of the interior finish to detach can be enhanced in several ways. In one embodiment, for example, the interior finish can comprise a heat shrinkable film, sheet, fiber, or fabric which can be a single layer or part of a multilayer structure, such as a laminate. The interior finish generally will comprise from 1 to 7 layers. Typically, the heat shrinkable film, sheet, fiber or fabric will have at least 20% shrinkage after 5 minutes exposure to water or air at 100° C. Further examples of shrinkage for such films, sheets, fibers, or fabrics are at least 30% shrinkage and at least 40% on exposure to water or air at 100° C. The preparation of heat shrinkable films, sheets, fibers, or fabrics typically is accomplished by imparting orientation to the article, for example, by stretching, and is well understood in the art. Upon exposure to heat from a flame, the heat shrinkable film or fiber will shrink or curl away from the heat of the flame. In another example, the interior finish can comprise a laminate in which one or more or the outer layers is a heat shrinkable film, sheet, fiber, or fabric. Exposure to heat from a flame will then cause the laminate to curl and detach from the wall and away from the heat of the flame.

The interior finish may be attached to a ceiling, one or more walls, or combination thereof in any manner which will permit the interior finish to at least partially detach upon exposure to the heat of a flame such as, for example, the heat from about a 40 to about a 160 kW flame as described in the United States National Fire Protection Agency Standard NFPA 286. During the early stages of a fire, the temperature of the room, especially in the proximity of a flame, will typically be 100° C. or greater. In one example, the interior finish may be attached to a ceiling, one or more walls, or a combination of ceiling and walls with 2 or more fasteners which are prepared from metals, metal alloys, or polymers that soften or melt at a temperature of about 70° C. to about 250° C. Examples of fasteners which may be used include, but are not limited to, screws, nails, bolts, rivets, clasps, brackets, adhesives, clamps, staples, tape, and combinations thereof. As the temperature of the room rises above above the melting or softening point of the fastener, the fastener softens or melts and releases the interior finish from the ceiling or wall. The fastener can be prepared using any metal, metal alloy, polymer or polymer blend which softens or melts at about 70° C. to about 250° C. such as, for example, polyolefins, polyesters, polyamides, styrenic polymers, combinations thereof, or copolymers thereof. The term “softening”, as used herein in the context of the present invention, is understood to mean the temperature at which modulus of the metal, metal alloy, or polymer, drops by at least 10 fold as measured by methods well known to persons of skill in the art such as, for example, by dynamic mechanical thermal analysis (“DMTA”). For example, fasteners could be prepared using a low melting metal alloys that are available commercially from the MCP Group under the trademarks MCP® 72 (mp 72° C.), MCP® 92 (mp 92° C.), MCP® 109 (mp 109° C.), MCP® 118 (mp 118° C.), MCP® 125 (mp 125° C.), MCP® 127 (mp 127° C.), MCP® 135 (mp 135° C.), MCP® 146 (mp 146° C.), MCP® 197 (mp 197° C.), and MCP® 221 (mp 221° C.). Representative examples of polymers which can be used for an adhesive or fastener in EPOLENE® N-10 (softening point 107-115° C.) and E-43 polyethylenes (available from Eastman Chemical Company), JET-MELT™ hot melt Adhesive 3748V-O and 3779 (available from 3M Company), and HYSOL® 7809FR and 7804FRM-HV Polyamide Hot-Melt Adhesives (available from Henkel-Loctite).

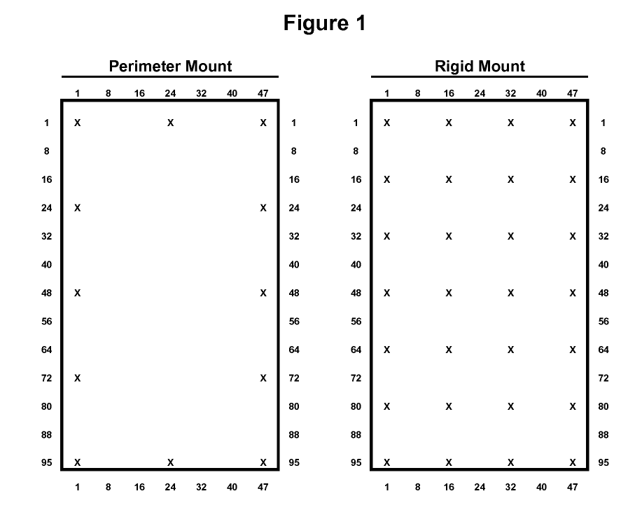

The method of attachment of the interior finish to the ceiling or wall can be related to the properties of the polymer. Thus, in addition to the chemical and physical characteristics of the materials described above, another aspect of the invention is a method for reducing flame spread, comprising: attaching at least one interior finish to a ceiling, one or more walls, or combination thereof, of a room with 2 or more fasteners, the interior finish having a total area of at least 10% of the total area of the ceiling and walls of the room and comprising a film, sheet, or profile comprising at least 80 weight percent, based on the total weight of the interior finish, of a polymer composition having a crystallization half-time of at least 5 minutes, a heat release capacity of about 400 J/g ° K or less, and a char generation of 20% or less, and the fasteners being separated by an average spacing, L, that is equal to or greater than a minimum distance, Lc, wherein L and Lc are defined by the following formulas:

$$L = \sqrt{\frac{Area}{N - 2 \sqrt{N} + 1}}$$

wherein
L is the average spacing in meters,
N is the number of the fasteners, and
Area is the area of the interior finish in square meters; and

$${L}_{C} = 2.69 \times {{10}^{- 7} [ exp ( \frac{- 19892}{75 exp ( - 308 \text{/} δ ) + 200 exp ( - 205 \text{/} δ ) + Tg - 653} ) ]}^{1 / 3}$$

wherein
Lc is the minimum distance in meters,
δ is the thickness in mils of the interior finish, and
Tg is the glass transition temperature of the polymer composition in ° C.
   Although the determination of the actual spacing for a given panel is simple for periodic or uniformity spaced mounting points, it can be tedious for non-uniformly spaced mounting points. It is convenient, therefore, to use the average spacing, L, between fasteners as defined by the above equation. This equation represents the square root of the reciprocal of the average number of fasteners per unit area of interior finish. The extra square root term in the denominator helps to correct for spacing and edge effects so as to better match up the calculated L with periodic grid spacing mounting distances. For example, the “rigid” mounted panel in FIG. 1 has 28 mount points and an area of 32 square feet (4608 square inches). The calculated value of L is 15.8 inches (0.41 meters) which is similar the actual horizontal and vertical spacing between grid points (15 to 1 6″). For the perimeter mounted panel, there are 12 mount points yielding a value of L=27 inches (0.70 meters). This value represents an effective averaging of the 24 inch spacing along the perimeter with the large unrestrained gap through the middle. Thus, according to the invention, if the value of L is equal to or greater than Lc, the panel would be predicted to detach or partially detach from the wall or ceiling.

In another example, in which the panels are glued or continuously fastened to the underlying surface, the number of mounting points or fasteners should be assumed to be approximately 1 per square inch of adhesive surface. Normally, a glued on panel is expected to fail the burn test; however, if such rigid fastening is only applied over a small portion of the panel, it can retain sufficient flexibility to detach or partially detach from the ceiling or wall on exposure to the heat of a flame. As an example of this, if a 4×8 foot panel is attached with 2 rigid mount strips (each 1 inch wide by 4 feet long), one on each end of the panel, this represents N=96 mount points and an effective L=7.7 inches.

The method includes the various aspects of the polymer composition, interior finishes, detachment of the interior finish, crystallization half-time, percent char generation, and heat release capacity as described above and in any combination. For example, the interior finish can have a total area of at least 10% of the total area of the ceiling and walls of a room. Other examples of the total area of the interior finishes of the instant invention are at least 20%, at least 30%, at least 40%, and at least 50% of the total area of the ceiling and walls of a room. The interior finish can detach by sagging, curling, peeling, falling away, shrinking, or foaming. In one embodiment, for example, the interior finish can comprise a heat shrinkable film, sheet, fiber, or fabric which can be a single layer or part of a multilayer structure, such as a laminate. The interior finish may further comprise a fiber, or fabric and may be in the form of a prefabricated panel. These heat shrinkable articles typically will exhibit at least 20% shrinkage on exposure to water or air at 100° C. Further examples of shrinkage for such films, sheets, fibers, or fabrics are at least 30% shrinkage and at least 40% on exposure to water or air at 100° C.

As noted above, the interior finish comprises at least 80 weight percent, based on the total weight of the interior finish, of a polymer composition which may comprise one or more polymers. Other examples of polymer composition weight percentage levels within the interior finish are at least 85 weight percent, at least 90 weight percent, at least 95 weight percent, at least 99 weight percent, and 100 weight percent. Non-limiting representative examples of polymers which may be used for the interior finish of the invention include polyesters, polyamides, polycarbonates, polypropylenes, polyethylenes, polyacrylates, cellulosics, poly(methylmethacrylate)s, copolymers thereof, and combinations thereof. In one example, the polymer composition may comprise 2 to 4 different polymers.

The polymer may advantageously have a crystallization half-time from the molten state or the glass state of at least 5 minutes. Additional examples of crystallization half-times from the molten or the glass state for the polymers of the interior finish include, but are not limited to, at least 10 minutes, and at least 100 minutes. As described previously, it is desirable that the polymer composition of the interior finish have a heat release capacity of 400 J/g ° K or less. Other representative examples of heat release capacities are 350 J/g ° K or less, and 300 J/g ° K or less. Also as noted hereinabove, the polymer of the interior finish may have a char generation of about 35% or less, typically 20% or less, more typically 15% or less, and most typically, 10% or less.

The interior finish can be fastened to the wall by using fasteners which may include any means of attachment known to persons skilled in the art such as, for example, screws, nails, bolts, rivets, clasps, clamps, staples, dowels, brackets, adhesives, and combinations thereof. Typically, to enable detachment or partial detachment of the interior finish during exposure to the heat of a flame, the means of attachment should be discrete and not continuous. For example, where the interior finish is attached to the ceiling or walls with a continuous film of adhesive covering the entire inside surface of the interior finish, the average spacing between the fasteners can be assumed to be 1 fastener/square inch. The spacing between the fasteners depend on the thickness of the sheet, film, or profile and the Tg of the polymer. For example, as the thickness of the sheet, film, or profile increases, the spacing between the fasteners also increases. Similarly, if the Tg of the polymer increases, the spacing between the fasteners also increase. For example, if the interior finish is point fastened to the wall in each corner, the sheet or film generally can detach partially or completely from the wall upon exposure to the heat of a flame. If too many fasteners are used, however, the interior finish may not be able to detach sufficiently and flame spread will not be reduced. Other factors may also affect the spacing between the points of attachment. For example, the addition of flame retardants to the polymer typically reduces its heat of deflection and will reduce the minimun spacing between the points of attachment.

For example, the polymer composition of the interior finish can comprise at least one polyester. The term “polyester”, as used herein, encompasses both “homopolyesters” and “copolyesters” and means a synthetic polymer prepared by the polycondensation of a diacid component, comprising one or more difunctional carboxylic acids, with a diol component, comprising one or more, difunctional hydroxyl compounds. Typically the difunctional carboxylic acid is a dicarboxylic acid and the difunctional hydroxyl compound is a dihydric alcohol such as, for example glycols and diols. Alternatively, the difunctional carboxylic acid may be a hydroxy carboxylic acid such as, for example, p-hydroxybenzoic acid, and the difunctional hydroxyl compound may be a aromatic nucleus bearing 2 hydroxy substituents such as, for example, hydroquinone. The term “residue”, as used herein, means any organic structure incorporated into the polymer through a polycondensation reaction involving the corresponding monomer. The dicarboxylic acid residue may be derived from a dicarboxylic acid monomer or its associated acid halides, esters, salts, anhydrides, or mixtures thereof. Thus, the diacid component of present invention is understood to comprise dicarboxylic acids as well as derivatives of dicarboxylic acids such as, for example, the associated acid halides, esters, half-esters, salts, half-salts, anhydrides, mixed anhydrides, or mixtures thereof.

The polyesters can comprise dicarboxylic acid monomer residues, diol monomer residues, and repeating units. Thus, the term “monomer residue”, as used herein, means a residue of a dicarboxylic acid, a diol, or a hydroxycarboxylic acid. A “repeating unit”, as used herein, means an organic structure having 2 monomer residues bonded through a carbonyloxy group. The polyesters of the present invention contain substantially equal molar proportions of acid residues (100 mole %) and diol residues (100 mole %) which react in substantially equal proportions such that the total moles of repeating units is equal to 100 mole %. The mole percentages provided in the present disclosure, therefore, may be based on the total moles of acid residues, the total moles of diol residues, or the total moles of repeating units. For example, a polyester containing 30 mole % of a monomer, which may be a dicarboxylic acid, a diol, or hydroxycarboxylic acid, based on the total repeating units, means that the polyester contains 30 mole % monomer out of a total of 100 mole % repeating units. Thus, there are 30 moles of monomer residues among every 100 moles of repeating units. Similarly, a polyester containing 30 mole % of a dicarboxylic acid monomer, based on the total acid residues, means the polyester contains 30 mole % dicarboxylic acid monomer out of a total of 100 mole % acid residues. Thus, in this latter case, there are 30 moles of dicarboxylic acid monomer residues among every 100 moles of acid residues.

The polymer composition of the present invention may comprise at least one polyester comprising at least 80 mole percent, based on the total moles of diacid residues, of the residues of one or more dicarboxylic acids selected from the group consisting of terephthalic acid, naphthalenedicarboxylic acid, 1,4-cyclohexanedicarboxylic acid, and isophthalic acid. Any of the various isomers of naphthalenedicarboxylic acid or mixtures of isomers may be used, but the 1,4-, 1,5-, 2,6-, and 2,7-isomers are preferred. In addition, 1,4-cyclohexanedicarboxylic acid may be used as as a pure cis or trans isomer or as a mixture of cis and trans isomers. The diacid residues may further comprise about 0 to 20 mole percent of the residues one or more modifying dicarboxylic acids selected from fumaric, succinic, adipic, glutaric, azelaic, sebacic, resorcinol diacetic, diglycolic, 4,4′-oxybis(benzoic), biphenyldicarboxylic, 4,4′-methylenedibenzoic, trans-4,4′-stilbenedicarboxylic, and sulfoisophthalic acids.

The polyester also may contain diol residues comprising about 10 to 100 mole percent, based on the total moles of diol residues, of the residues of one or more diols selected from 1,4-cyclohexanedimethanol; neopentyl glycol; 2,2,4,4-tetramethyl-1,3-cyclobutanediol, and ethylene glycol. The 1,4-cyclohexanedimethanol may be used as a pure cis or trans isomer or as a mixture of cis and trans isomers. In addition to the above diols, the diol residues may comprise about 0 to 90 percent of the residues of one or more diols selected from diethylene glycol, 1,2-propanediol, 1,3-propanediol, 1,4-butanediol, 1,5-pentanediol, 1,6-hexanediol, 1,8-octanediol, 2,2,4-trimethyl-1,3-pentanediol, 1,3-cyclohexanedimethanol, bisphenol A, and polyalkylene glycol.

For example, the interior finish may comprise a polyester comprising from about 60 to 100 mole percent of the residues of terephthalic acid and 0 to about 40 mole percent of the residues isophthalic acid. In another example, the diacid residues of the polyester may comprise about 95 mole percent of the residues of terephthalic acid and about 5 mole percent of the residues of isophthalic acid. In yet another example, the diacid residues may comprise 100 mole percent of the residues terephthalic acid. Additional examples of polyesters that may be used in the interior finish of the invention include polyesters having diacid residues comprising 100 mole percent of the residues of terephthalic acid and diol residues comprising about 10 to about 40 mole percent of the residues of 1,4-cyclohexanedimethanol and 60 to about 90 mole percent of the residues of ethylene glycol; and polyesters in which the diol residues comprise about 10 to about 99 mole percent of the residues of 1,4-cyclohexanedimethanol, 0 to about 90 mole percent of the residues of ethylene glycol, and about 1 to about 25 mole percent of the residues of diethylene glycol.

The polyesters generally will have inherent viscosity (I.V.) values in the range of about 0.5 dL/g to about 1.4 dL/g. Additional examples of I.V. ranges include about 0.65 dL/g to about 1.0 dL/g and about 0.65 dL/g to about 0.85 dL/g. The inherent viscosity is measured at 25° C. using 0.25 gram of polymer per 50 mL of a solvent composed of 60 weight percent phenol and 40 weight percent tetrachloroethane.

The polyesters which may be used in the method of the instant invention are readily prepared from the appropriate dicarboxylic acids, esters, anhydrides, or salts, and the appropriate diol or diol mixtures using typical polycondensation reaction conditions. They may be made by continuous, semi-continuous, and batch modes of operation and may utilize a variety of reactor types. Examples of suitable reactor types include, but are not limited to, stirred tank, continuous stirred tank, slurry, tubular, wiped-film, falling film, or extrusion reactors. The process typically is operated advantageously as a continuous process for economic reasons and to produce superior coloration of the polymer as the polyester may deteriorate in appearance if allowed to reside in a reactor at an elevated temperature for too long a duration.

The polyesters of the present invention are prepared by procedures known to persons skilled in the art. The reaction of the diol and dicarboxylic acid may be carried out using conventional polyester polymerization conditions or by melt phase processes, but those with sufficient crystallinity may be made by melt phase followed by solid phase polycondensation techniques. For example, when preparing the polyester by means of an ester interchange reaction, i.e., from the ester form of the dicarboxylic acid components, the reaction process may comprise two steps. In the first step, the diol component and the dicarboxylic acid component, such as, for example, dimethyl terephthalate, are reacted at elevated temperatures, typically, about 150° C. to about 250° C. for about 0.5 to about 8 hours at pressures ranging from about 0.0 kPa gauge to about 414 kPa gauge (60 pounds per square inch, “psig”). Preferably, the temperature for the ester interchange reaction ranges from about 180° C. to about 230° C. for about 1 to about 4 hours while the preferred pressure ranges from about 103 kPa gauge (15 psig) to about 276 kPa gauge (40 psig). Thereafter, the reaction product is heated under higher temperatures and under reduced pressure to form the polyester with the elimination of diol, which is readily volatilized under these conditions and removed from the system. This second step, or polycondensation step, is continued under higher vacuum and a temperature which generally ranges from about 230° C. to about 350° C., preferably about 250° C. to about 310° C. and, most preferably, about 260° C. to about 290° C. for about 0.1 to about 6 hours, or preferably, for about 0.2 to about 2 hours, until a polymer having the desired degree of polymerization, as determined by inherent viscosity, is obtained. The polycondensation step may be conducted under reduced pressure which ranges from about 53 kPa (400 torr) to about 0.013 kPa (0.1 torr). Stirring or appropriate conditions are used in both stages to ensure adequate heat transfer and surface renewal of the reaction mixture. The reaction rates of both stages are increased by appropriate catalysts such as, for example, alkoxy titanium compounds, alkali metal hydroxides and alcoholates, salts of organic carboxylic acids, alkyl tin compounds, metal oxides, and the like. A three-stage manufacturing procedure, similar to that described in U.S. Pat. No. 5,290,631, may also be used, particularly when a mixed monomer feed of acids and esters is employed.

To ensure that the reaction of the diol component and dicarboxylic acid component by an ester interchange reaction is driven to completion, it is sometimes desirable to employ about 1.05 to about 2.5 moles of diol component to one mole dicarboxylic acid component. Persons of skill in the art will understand, however, that the ratio of diol component to dicarboxylic acid component is generally determined by the design of the reactor in which the reaction process occurs.

In the preparation of a polyester by direct esterification, i.e., from the acid form of the dicarboxylic acid component, polyesters are produced by reacting the dicarboxylic acid or a mixture of dicarboxylic acids with the diol component or a mixture of diol components. The reaction is conducted at a pressure of from about 7 kPa gauge (1 psig) to about 1379 kPa gauge (200 psig), preferably less than 689 kPa (100 psig) to produce a low molecular weight polyester product having an average degree of polymerization of from about 1.4 to about 10. The temperatures employed during the direct esterification reaction typically range from about 180° C. to about 280° C., more preferably ranging from about 220° C. to about 270° C. This low molecular weight polymer may then be polymerized by a polycondensation reaction.

In addition, the polyesters may further comprise one or more of the following: antioxidants, melt strength enhancers, branching agents (e.g., glycerol, trimellitic acid and anhydride), chain extenders, flame retardants, fillers, acid scavengers, dyes, colorants, pigments, antiblocking agents, flow enhancers, impact modifiers, antistatic agents, processing aids, mold release additives, plasticizers, slips, stabilizers, antioxidants, waxes, UV absorbers, optical brighteners, lubricants, pinning additives, foaming agents, antistats, nucleators, glass beads, metal spheres, ceramic beads, carbon black, crosslinked polystyrene beads, and the like. Colorants, sometimes referred to as toners, may be added to impart a desired neutral hue and/or brightness to the polyester. Preferably, the polyester compositions may comprise 0 to about 30 weight percent of one or more processing aids to alter the surface properties of the composition and/or to enhance flow. Representative examples of processing aids include calcium carbonate, talc, clay, mica, zeolites, wollastonite, kaolin, diatomaceous earth, TiO₂, NH₄Cl, silica, calcium oxide, sodium sulfate, and calcium phosphate. Use of titanium dioxide and other pigments or dyes, might be included, for example, to control whiteness or to make a colored polymer. The polyesters may contain small amounts, typically 2 mole % or less, based on the total moles of diacid or diol residues, of the residues of one or more branching agents if desired. Typical levels of branching agents are about 0.1 to about 1.5 mole %, about 0.1 to about 1.0 mole %, and about 0.1 to about 0.5 mole %. Conventional branching agents include polyfunctional acids, anhydrides, alcohols and mixtures thereof. Examples of suitable branching agents include, but are not limited to, trimellitic anhydride, pyromellitic dianhydride, glycerol, trimethylolpropane and pentaerythritol.

The interior finish also may be offset at a distance of about 0.5 cm to about 20 cm from the ceiling or wall. In this embodiment, the magnitude of the thickness of the interior finish on the distance between the fasteners is reduced by ½. Another embodiment of the invention, therefore, is a method for reducing flame spread, comprising: attaching at least one interior finish to a ceiling, one or more walls, or combination thereof, of a room with 2 or more fasteners, wherein at least a portion of the inside surface of the interior finish is positioned at about 0.5 cm to about 20 cm from the surface of the ceiling or walls, the interior finish having a total area of at least 10% of the total area of the ceilings and walls and comprising a film, sheet, or profile comprising at least 80 weight percent, based on the total weight of the interior finish, of a polymer composition having a crystallization half-time of at least 5 minutes, a heat release capacity of 400 J/g ° K or less, and a char generation of 20% or less, and the fasteners being separated by an average spacing, L, that is equal to or greater than a minimum distance, Lc, wherein L and Lc are defined by the following formulas:

$$L = \sqrt{\frac{Area}{N - 2 \sqrt{N} + 1}}$$

wherein
L is the average spacing in meters,
N is the number of the fasteners, and
Area is the area of the interior finish in square meters; and

$${L}_{C} = 2.69 \times {{10}^{- 7} [ exp ( \frac{- 19892}{75 exp ( - 308 \text{/} δ ) + 200 exp ( - 205 \text{/} δ ) + Tg - 653} ) ]}^{1 / 3}$$

wherein
Lc is the minimum distance in meters,
δ is ½ of the thickness in mils of the interior finish, and
Tg is the glass transition temperature of the polymer composition in ° C.
   The method is understood to include the various aspects of the polymer composition, interior finishes, detachment of the interior finish, crystallization half-time, percent char generation, and heat release capacity as described above and in any combination.

In yet another aspect of the invention, the interior finish may be attached to a ceiling, one or more walls, or a combination of ceiling and walls, with 2 or more fasteners which are prepared from metals, metal alloys, or polymers that soften or melt at a temperature of about 70° C. to about 250° C. Thus, the invention also includes, a method for reducing flame spread, comprising: attaching at least one interior finish to a ceiling, one or more walls, or combination thereof, of a room, with 2 or more fasteners which soften or melt at a temperature of about 70° C. to about 250° C., the interior finish comprising at least 50 weight percent of combustable substrate and having a total area of at least 10% of the total area of the walls and ceilings. The method may include the various aspects of the polymer composition, interior finishes, detachment of the interior finish, crystallization half-time, percent char generation, and heat release capacity as described above in any combination. For example, the total area of the interior finish can be at least 20%, at least 30%, at least 40%, and at least 60% of the total area of the walls and ceilings.

Upon exposure to elevated temperatures, the interior finish detaches from the wall or ceiling by softening or melting of the fasteners. Examples of fasteners which may be used include, but are not limited to, screws, nails, bolts, rivets, clasps, brackets, adhesives, clamps, staples, tape, and combinations thereof. As the temperature of the room rises above above the melting or softening point of the fastener, the fastener softens or melts and releases the interior finish from the ceiling or wall. As described previously, the fastener can be prepared using any metal, metal alloy, polymer or polymer blend which softens or melts at about 70° C. to about 250° C. such as, for example, polyolefins, polyesters, polyamides, styrenic polymers, combinations thereof, or copolymers thereof. The term “softening”, as used herein in the context of the present invention, is understood to mean the temperature at which modulus of the metal, metal alloy, or polymer, drops by at least 10 fold as measured by methods well known to persons of skill in the art such as, for example, by dynamic mechanical thermal analysis (“DMTA”). For example, fasteners could be prepared using a low melting metal alloys that are available commercially from the MCP Group under the trademarks MCP® 72 (mp 72° C.), MCP® 92 (mp 92° C.), MCP® 109 (mp 109° C.), MCP® 118 (mp 118° C.), MCP® 125 (mp 125° C.), MCP® 127 (mp 127° C.), MCP® 135 (mp 135° C.), MCP® 146 (mp 146° C.), MCP® 197 (mp 197° C.), and MCP® 221 (mp 221° C.). Representative examples of polymers which can be used for an adhesive or fastener in EPOLENE® N-10 (softening point 107-115° C.) and E-43 polyethylenes (available from Eastman Chemical Company), JET-MELT™ hot melt Adhesive 3748V-O and 3779 (available from 3M Company), and HYSOL® 7809FR and 7804FRM-HV Polyamide Hot-Melt Adhesives (available from Henkel-Loctite).

As described previously, the interior finish can comprise a sheet, film, fiber, fabric, profile, or prefabricated panel and comprises at least 50 weight percent of combustable substrate. For example, the interior finish can comprise wood or at least one polymer. Examples of polymers include, but are not limited to, polyesters, polyamides, polycarbonates, polypropylenes, polyethylenes, polyacrylates, cellulosics, poly(methylmethacrylate)s, combinations thereof, and copolymers thereof.

Upon softening or melting of the fasteners, the interior finish can detach or partially detach from the ceiling or wall by any of the mechanisms described above such as, for example, by sagging, curling, peeling, falling away, or shrinking. For example, the interior finish may detach by all or a portion of the interior finish moving out of the plane of the ceiling or wall.

The interior finish, as noted previously, can comprise a heat shrinkable polymer to enhance the detachment from the ceiling or wall. For example, the interior finish can comprise a heat shrinkable film, sheet, fiber, or fabric which has at least 20% shrinkage after 5 minutes exposure to water or air at 100° C.

### EXAMPLES

General—The invention is further illustrated by the following examples. Interior finishes as well as other materials for building and construction applications are subject to flammability requirements that include specifications related to the flame spread and smoke generation. In examples 1-17, 4 ft by 8 ft polymer sheets were tested according to the National Fire Protection Agency standard NFPA 286 entitled “Standard Methods of Fire Tests for Evaluating Contribution of Wall and Ceiling Interior Finish to Room Fire Growth.” The composition of the sheets is provided in Tables 2 and 3. There are analogous test standards specified in other countries that are similar to this test. This NFPA 286 test method used a gas burner to produce a diffusion flame to expose the walls in the corner of a room. The burner supplies a net rate of heat output of 40 kW for 5 minutes followed by 160 kW for 10 minutes. The total exposure was 15 minutes. The test was conducted with natural ventilation to the test room provided through a single doorway. The contribution of the interior finish material to the fire growth was measured by constant monitoring of the incident heat flux on the center of the floor, the temperature of the gases generated, the rate of heat release, the smoke release, and the time to flashover.

Variables in the NFPA 286 test included the composition of the sheet, the configuration of the material, and the method of attachment or mounting technique for the material. The configuration options were as follows: walls only, ceiling only, or walls and ceiling combinations. In addition to the test configuration, the method of attaching the material to the wall also was varied. Further definition of test configurations and mounting techniques are provided below. The NFPA test was recorded on a video camera and the amount of detachment of the interior finish from the ceiling or walls (as a percent of the total area of the interior finish panel exposed to the heat of the flame) was estimated from this video. Flame spread and smoke generation were determined by the NFPA 286 test criteria; thus, a sample passing the test was judged to have less flame spread than a sample failing the test. The NFPA acceptance criteria is given in Table 1:

TABLE 1
NFPA 286 Acceptance Criteria

| | |
|---|---|
| A. | During the 40 kW exposure, the interior finish shall comply with |
| | Item 1. |
| B. | During the 160 kW exposure, the interior finish shall comply with |
| | Item 2. |
| C. | During the entire test, the interior finish shall comply with Item 3. |

Items 1-3:

| | |
|---|---|
| 1. | During the 40 kW exposure, flames shall not spread to the ceiling. |
| 2. | During the 160 kW exposure, the interior finish shall comply with the |
| | following: |
| | 2.1 Flame shall not spread to the outer extremity of the sample on any |
| | wall or ceiling. |
| | 2.2 Flashover, as defined in NFPA 286, shall not occur. |
| 3. | The total smoke released throughout the NFPA 286 shall not exceed |
| | 1,000 m². |

Flashover is determined to have occurred when any two of the following
conditions have been attained:

(1) The heat release rate exceeds 1 MW.
(2) Heat flux at the floor exceeds 20 kW/m².
(3) The average upper layer temperature exceeds 600° C. (1112° F.).
(4) Flames exit the doorway.
(5) Autoignition of a paper target on the floor occurs.

Walls Only Configuration—For this test, the specimen was mounted on three walls (the rear wall and both side walls). The room construction created for this test was an ASTM standard 8′×8′×12′ wood stud construction. The interior of the construction was covered with ⅝″ type X gypsum wallboard. Two sheets of the material with dimensions 8′×4′ were attached to the back wall and three sheets were attached to each of the side walls of the structure for 8 sheets total. The sheets were fastened to the ⅝″ type X gypsum wallboard using #6×2″ bugle head screws with 2″ diameter fender washers.

Ceiling Only Configuration—For this configuration, the specimen was mounted on the ceiling of the test room. The room construction created for this test was an ASTM standard 8′×8′×12′ wood stud construction. The interior of the construction was covered with ⅝″ type X gypsum wallboard. Three sheets of material were attached to the ceiling of the structure. The sheets were fastened to the ⅝″ type X gypsum wallboard using #6×2″ bugle head screws with 2″ diameter fender washers.

Walls and Ceiling Configuration—For this configuration, the specimen was mounted on three walls (the rear wall and both side walls) and the ceiling of the test room. The room construction created for this test was an ASTM standard 8′×8′×12′ wood stud construction. The interior of the construction was covered with ⅝″ type X gypsum wallboard. Two sheets of the material were attached to the back wall and three sheets were attached to each of the side walls and on the ceiling of the structure for 11 sheets total. The sheets were fastened to the ⅝″ type X gypsum wallboard using #6×2″ bugle head screws with 2″ diameter fender washers.

Mounting Techniques—The materials in this test can be mounted and attached according to the typical application process. FIG. 1, illustrates the mounting patterns for the 4 foot by 8 foot sheets used in Examples 1-28. In FIG. 1, the dimensions along each axis of the sheets are given in inches. Two mounting patterns were tested: a perimeter mounting method where fasteners were placed along the perimeter of the sheet at approximately 23-24 inch intervals and a rigid mounting method where fasteners were place along the perimeter and in the interior of the sheet spaced at approximately 15-16 inch intervals. The corresponding average spacing, L, for the perimeter mounted samples was 27 inches (0.70 meters) and for the rigid mounted samples, 15.8 inches (0.41 meters) and was calculated using the following formula:

$$L = \sqrt{\frac{Area}{N - 2 \sqrt{N} + 1}}$$

wherein
N is the number of fasteners on the interior finish
Area is the area of the interior finish in square meters or square inches
   The actual spacings and the average spacings as calculated by the above formula are shown in Table 3. For most interior decorations, the perimeter mounting process is preferred; however, in some cases a more rigid mounting technique may be required. It should be noted that the minimum spacing Lc, as used herein in the present specification and the claims refers to the minimum spacing between mount points or fasteners in any direction (e.g. horizontal, vertical, diagonal, etc.).

Heat Release Capacity—The heat release capacity was calculated using the group contribution method provided in the paper entitled “Molar Group Contributions to Polymer Flammability” in Journal of Applied Polymer Science, Vol 87 (2003), pages 548-563. For copolymers, the contribution to heat release capacity for each repeat unit was calculated using the group contribution method and then the heat release capacity for the copolymer was determined as a weighted average based on mole fraction of each repeat unit and the respective molar heat release capacities. For blends and/or polymer laminates, the heat release capacity for each polymer was calculated using the group contribution method and then the total heat release capacity for the blend was approximated as a weighted average based upon the weight fractions and the respective specific heat release capacities.

Crystallization Half Time—The crystallization half time of the polyester can be measured using a Perkin-Elmer Model DSC-2 differential scanning calorimeter. The crystallization half time is measured from the molten state using the following procedure: a 10 mg sample of the polyester is sealed in an aluminum pan and heated to 290° C. at a rate of about 320° C./min for 2 minutes. The sample is then cooled immediately to the predetermined isothermal crystallization temperature at a rate of about 320° C./minute in the presence of helium. The isothermal crystallization temperature is the temperature between the glass transition temperature and the melting temperature that gives the highest rate of crystallization. The isothermal crystallization temperature is described, for example, in Elias, H. Macromolecules, Plenum Press: NY, 1977, p 391. The crystallization half time is determined as the time span from reaching the isothermal crystallization temperature to the point of a crystallization peak on the DSC curve. The crystallization half time is measured from the glass state using the following procedure: a 10 mg sample of the polyester is sealed in an aluminum pan and heated to 290° C. at a rate of about 320° C./min for 2 minutes. The sample is then quenched on a chilled block to a temperature below 0° C. The sample is then placed back into the DSC and heated to the predetermined isothermal crystallization temperature at a rate of about 320° C./minute in the presence of helium. The crystallization half time is again determined as the time span from reaching the isothermal crystallization temperature to the point of a crystallization peak on the DSC curve. In the case of blends, the crystallization half-time should be measured directly using the blend. In the case of panels consisting of laminates of different polymers, the half-times for each layer should be measured separately. The effective crystallization half time for the entire structure is then taken to be the thickness averaged value based on the individual half-times for each layer.

Crystallization half time can also be determined by Small Angle Laser Light Scattering (SALLS) by measuring the light transmission of a sample via a laser and photo detector as a function of time on a temperature controlled hot stage. This measurement is carried out by exposing the polymers to a temperature above its melting point and then cooling it to the desired test temperature. The sample is then held at the desired temperature by a hot stage while transmission measurements were made as a function of time. Initially, the sample is visually clear with high light transmission and became opaque as the sample crystallized. The crystallization half-time is recorded as the time at which the light transmission was halfway between the initial transmission and the final transmission.

Glass Transition Temperature—The glass transition temperature Tg, was determined using differential scanning calorimetry (DSC) at a heating rate of 20° C./minute. For immiscible blends having multiple glass transitions, the glass transition temperature for is taken to be the weighted average of the Tg's of the individual blend components. This is done to reflect the intermediate softening temperature for the structural/modeling calculations. For laminates, each layer typically will have a separate glass transition such that the same weighted average approach should be used in manner similar to that described above for immiscible blends.

Char—Char was determined using thermal gravimetric analysis (TGA) as the weight percent residual mass following heated from 300° C. to 600° C. at a scan rate of 20° C. per minute in nitrogen atmosphere. An example of a thermal gravimetric analyzer is the TA Instruments Model 2950. For blends and laminates, it is preferable to measure the effective char directly using samples representative of the blend/laminate structure. If sample size limitations of many TGA instruments prevents direct measurement, the char value also can be estimated for blends and laminates using the weighted average of the char values for the individual components.

Polymer Samples—Examples 1-28 used the following polymer compositions shown in Table 2:

TABLE 2

| Poly- | Polymer | |
|---|---|---|
| mer | Type | Approximate Composition |
| A | Polyester | 100 mole % terephthalic acid, 4.5 mole % 1,4- |
| | | cyclohexane-dimethanol, 95.5 mole % ethylene glycol |
| B | Polyester | 100 mole % terephthalic acid, 12 mole % 1,4- |
| | | cyclohexane-dimethanol, 88 mole % ethylene glycol |
| C | Polyester | 100 mole % terephthalic acid, 31 mole % 1,4- |
| | | cyclohexane-dimethanol, 69 mole % ethylene glycol |
| D | Polyester | 100 mole % terephthalic acid, 62 mole % 1,4- |
| | | cyclohexane-dimethanol, 38 mole % ethylene glycol |
| E | Polyester | 100 mole % terephthalic acid, 81 mole % 1,4- |
| | | cyclohexane-dimethanol, 19 mole % ethylene glycol |
| F | Polyester | 74 mole % terephthalic acid, 26 moles % isophthalic |
| | | acid, 100 mole % 1,4-cyclohexanedimethanol |
| G | Polyester | 65 mole % terephthalic acid, 35 moles % isophthalic |
| | | acid, 100 mole % 1,4-cyclohexanedimethanol |
| H | Poly- | General purpose bisphenol A polycarbonate (Hyzod ® |
| | carbonate | polycarbonate, available from Sheffield) |
| I | Acrylic | General purpose poly(methylmethacrylate) (Optix ® |
| | | GP Acrylic, available from Plaskolite) |
| J | Polyester | 100 mole % 1,4-cyclohexanedicarboxylic acid, 100 |
| | | mole % 1,4-cyclohexanedimethanol |

### Example 1

Sheet samples of polymer A having a thickness of 0.236 inches (6 mm) were tested according to NFPA 286 using the walls only configuration and the perimeter mounting technique. Visible inspection during the burn test showed no discernable peeling or sagging of the sheet during the initial low burn phase of the test. As a result, the sheet did not comply with item 2 of the acceptance criteria as defined by the test.

### Example 2

Sheet samples of polymer B having a thickness of 0.236 inches (6 mm) were tested according to NFPA 286 using the tested in a walls only configuration and the perimeter mounting technique. About 3 minutes into the test, both corner panels showed mild distortion or “shimmering” across 50 to 75% of their respective surfaces. This distortion is from softening of the sheet and relaxation of molded in stresses (e.g. polishing induced stresses). After about 4 minutes, there was noticeable curling in the corner above the flame of about 5% to 10% of the total panel surface area. The test sample showed curling and sagging in the vicinity of, and above the flame, to the extent that it was not in the direct flame for much of the low burn phase of the test. During the high burn phase, the panels curled/distorted away from the flame over about 50% of the surface area. The sample passed all of the acceptance criteria as defined by the test.

### Example 3

Sheet samples of polymer C having a thickness of 0.236 inches (6 mm) were tested according to NFPA 286 using the walls only configuration and the perimeter mounting technique. Within the first 2 minutes of the test, flow-type lines appeared at the top 10% or so of the panels indicating that distortion was already beginning to occur. Wavelike distortions were visible over 60 to 70% of the panel surface within the first 4 minutes, and curling of the sheet in the corner of the room was visible over 5 to 10% of the sheet. During the high watt burn stage, curling sagging was visible over about 50% of the panel surface in a direction downward and away from the flame. The test sample passed all of the acceptance criteria as defined by the test.

### Example 4

Sheet samples of polymer D having a thickness of 0.236 inches (6 mm) were tested according to NFPA 286 using the tested in a walls only configuration and the perimeter mounting technique. At about 3.5 minutes, the sheet showed what appeared to be significant darkening and/or warping over about 50% of its surface. Significant curling away from the flame occurred in the vicinity of the flame over about 5% of the surface area. During the high watt burn portion of the test, distortion/sagging away from the flame occurred over about 75% of the panel. The test sample passed all of the acceptance criteria as defined by the test.

### Example 5

Sheet samples of polymer E having a thickness of 0.236 inches (6 mm) were tested according to NFPA 286 using the walls only configuration and the perimeter mounting technique. The test sample showed some signs of curling in the immediate vicinity of the flame, as well as distortion over about 50% of the surface area at 4 minutes, but the sheet still ignited and the flame began to spread. As a result, the sample did not comply with item 2 of the acceptance criteria as defined by the test.

### Example 6

Sheet samples of polymer F having a thickness of 0.236 inches (6 mm) were tested according to NFPA 286 using the walls only configuration and the perimeter mounting technique. The test sample showed wavelike distortion over about 50% of the surface area at 3 minutes, along with significant distortion over about 5% of the area above and in the vicinity of the flame. The sheet ignited and did not comply with item 2 of the acceptance criteria as defined by the test.

### Example 7

Sheet samples of polymer G having a thickness of 0.236 inches (6 mm) were tested according to NFPA 286 using the tested in a walls only configuration and the perimeter mounting technique. The test sample showed localized signs of curling/sagging in the vicinity of the flame over about to 10% of the surface area, but still ignited. The sample did not comply with item 2 of the acceptance criteria as defined by the test.

### Example 8

Sheet samples of polymer C having a thickness of 0.080 inches (2 mm) were tested according to NFPA 286 using the walls only configuration and the perimeter mounting technique. The panel surface showed severe, visible waviness and distortion over 80% of the surface area within the first minute of the test. Within 4 minutes, the sheet had curled away from the flame over 40 to 50% of the surface area. The test sample complied with all of the acceptance criteria as defined by the test.

### Example 9

Sheet samples of polymer C having a thickness of 0.236 inches (6 mm) were tested according to NFPA 286 using the walls and ceiling only configuration and the perimeter mounting technique. The panels began to show flow-type distortion lines over 30 to 40% of the surface area within the first couple of minutes, expanding to almost 100% of the surface area within 3 to 4 minutes. Curling/sagging occurred over about 20% of the area in the vicinity of the flame (i.e. sagging induced deflections in the sheet of a few inches away from the flame). In the latter stages of the burn test, some sagging was also observed in the corner of the ceiling panel. The wall panels had distorted away from the flame and were not ignited by the test flame. The test sample complied with all of the acceptance criteria as defined by the test.

### Example 10

Sheet samples of polymer C having a thickness of 0.236 inches (6 mm) were tested according to NFPA 286 using the walls and ceiling only configuration and the rigid mounting technique. The samples were exposed for 5 minutes to a 40 kW flame and, thereafter, to a 160 kW flame. Some of the sheet surface in the vicinity of the test flame (<5% surface area) were observed to begin peeling away after 6 minutes and 30 seconds but the more rigid mounting prevented any significant deformation. In the later stages of the test, the wall panels ignited and allowed flame contact over a square foot or more of the ceiling panel, thereby leading to failure. The test sample did not comply with item 2 of the acceptance criteria as defined by the test.

### Example 11

Sheet samples of polymer H having a thickness of 0.236 inches (6 mm) were purchased and were tested according to NFPA 286 using the walls and ceiling configuration and the perimeter mounting technique. Because polymer H is an amorphous polymer, its crystallization half time was estimated to be >2000 minutes. The sheet showed signs of distortion and “shimmering” across its entire face within the first three minutes of the test. It also showed some distortion and bowing in the top corner above the flame (about 5-10% surface area) but only on a small scale, as the sheet still did not appear to move fully out of the flame. Furthermore, even during the high watt burn, the sheet did not appear to sag away from the flame, but instead stayed in place allowing combustion and considerable smoke generation. Some of this lack of sagging was due to noticeable char formation which prevented any further sheet mobility. The test sample did not comply with items 2 and 3 the acceptance criteria as defined by the test.

### Example 12

Sheet samples of polymer I having a thickness of 0.236 inches (6 mm) were purchased and were tested according to NFPA 286 using the walls and ceiling configuration and the perimeter mounting technique. Because polymer I is an amorphous polymer, its crystallization half time was estimated to be >2000 minutes. The test sample ignited before it showed any signs of sagging or curling and did not meet item 1 of the acceptance criteria as defined by the test.

### Example 13

Sheet samples were prepared from a general purpose blend of 67 wt % polymer D (Tiglaze ST®, available from Eastman Chemical Company), 30 wt % of polymer H, having a melt index of 8, and 3% of Weston 619 concentrate (a phosphite stabilizer concentrate) in polymer D. The sheets had a thickness of 0.236 inches (6 mm) and were tested according to NFPA 286 using a walls and ceiling configuration and the perimeter mounting technique. The panel showed some wavelike/shimmering distortion across 10 to 20% of the panel face within the first 2 minutes, expanding to about 75% of the panel within 4 minutes. In the vicinity of the flame there was little curling (<5% area), even during the high burn. The sheet was found to ignite and the flame propagate. As a result, it did not comply with item 2 of the acceptance criteria as defined by the test.

### Example 14

Sheet samples were prepared from a general purpose blend of 47 wt % polymer D (Tiglaze ST®, available from Eastman Chemical Company), 50 wt % of polymer H, having a melt index of 13, and 3% of Weston 619 concentrate (a phosphite stabilizer concentrate) in polymer D. The sheets had a thickness of 0.236 inches (6 mm) and were tested according to NFPA 286 using a walls only configuration and the perimeter mounting technique. The test sample was similar to Example 13 above and did not comply with item 2 of the acceptance criteria as defined by the test.

### Example 15

Sheet samples were prepared from a general purpose blend of 27 wt % polymer D (Tiglaze ST®, available from Eastman Chemical Company), 70 wt % of polymer H, having a melt index of 13, and 3% of Weston 619 concentrate (a phosphite stabilizer concentrate) in polymer D. The sheets had a thickness of 0.236 inches (6 mm) and were tested according to NFPA 286 using the walls only configuration and the perimeter mounting technique. The test sample showed mild wavelike distortions over approximately 20% of the sheet within the first 3 minutes extending to about 75% coverage after 4 to 5 minutes. However, no distinguishable curling occurred in the proximity of the flame. Upon transition to the high watt burn stage, the sheet ignited and flames began to propagate. As a result, the sample not comply with item 2 of the acceptance criteria as defined by the test.

### Example 16

Sheet samples were prepared from general purpose blend of 47 wt % polymer J, 50 wt % of polymer, having a melt index of 8, and 3% of Weston 619 concentrate (a phosphite stabilizer concentrate) in polymer D. The sheets had a thickness of 0.236 inches (6 mm) and were tested according to NFPA 286 using the walls only configuration and the perimeter mounting technique. After 3 minutes, a wave type distortion was seen to propagate across about 30% of the panel. Furthermore, there was some curling/deformation over about 5 of the sheet in the vicinity of the flame. The sample also showed signs of soot formation in the early stages. Upon transitioning to the high watt burn, the sheet ignited and the flames propagated. It also appeared that soot formation prevented any further curling of the sheet. The test sample did not comply with item 2 of the acceptance criteria as defined by the test.

### Example 17

Sheet samples of polymer C with 9.2 wt % resorcinol diphosphate (RDP) as a flame retardant and having a thickness of 0.236 inches (6 mm) were tested according to NFPA 286 using the walls only configuration and the perimeter mounting technique. Wave like distortions occurred over about 50% of the panel within the first 4 to 5 minutes. Peeling/curling over about 10 to 15% of the sheet occurred above, and in the vicinity of the flame. The panels showed curling/sagging of at least a few inches away from the flame. During the high burn stage, curling continued to occur over about 75% of the area after 8 minutes. The test sample complied with all of the acceptance criteria as defined by the test.

### Example 18

Sheet samples of polymer B having a thickness of 0.236 inches (6 mm) were tested according to NFPA 286 using the tested in a walls only configuration and the rigid mounting technique. The panels showed little deformation during the low watt burn portion of the test (only about 20% wavelike distortion over the bottom portion of the panel). During the high burn portion of the test, the material peel back just far enough to stay outside of the flame. Surface coverage for this peeling area was about 5%. As the high burn phase continued, the panel appeared to sag and flow around the melt points over about 50% of the panel area. The test sample passed all of the acceptance criteria as defined by the test and showed sagging/curling away from the flame during the test.

### Example 19

Sheet samples of polymer B having a thickness of 0.060 inches (1.5 mm) were tested according to NFPA 286 using the tested in a walls only configuration and the rigid mounting technique. The sample showed significant curling and warping within the first 2 minutes of the test over the full panel. In the immediate vicinity of the flame, curling occurred over about 20% of the area. During the high burn phase, the panel showed significant deformation over about 30 to 40% of the panel such that the flame was not in direct contact with the sheet. The test sample passed all of the acceptance criteria as defined by the test.

### Example 20

Sheet samples of polymer B having a thickness of 0.060 inches (1.5 mm) were tested according to NFPA 286 using the tested in a walls only configuration and the perimeter mounting technique. The sample showed curling across the whole panel (75% or more coverage). Sections in the vicinity of the flame were observed to peel away and sag by as much as one foot away from the flame. The test sample passed all of the acceptance criteria as defined by the test.

### Example 21

Sheet samples of polymer C having a thickness of 0.236 inches (6 mm) were tested according to NFPA 286 using the walls only configuration and the rigid mounting technique. There was no visible distortion of the sheet due to the more rigid mounting for the first five minutes of the low burn phase. Upon tranition to the high watt burn, there was visible some distortion over about 10% of the area near the flame. After 8 minutes, there was peeling away over about 10 to 20% of the panel in the vicinity of the flame. After 10 minutes, the whole panel appeared to be trying to flow around the mount points. The test sample passed all of the acceptance criteria as defined by the test.

### Example 22

Sheet samples of polymer C having a thickness of 0.060 inches (1.5 mm) were tested according to NFPA 286 using the walls only configuration and the perimeter mounting technique. The panel showed curling/sagging away from the flame across the whole panel surface. In the vicinity of the flame, sheet curling was 6 inches or more of deflection in some places. The test sample passed all of the acceptance criteria as defined by the test.

### Example 23

Sheet samples of polymer C having a thickness of 0.150 inches (3.8 mm) were tested according to NFPA 286 using the walls only configuration and the perimeter mounting technique. The test sample showed wavelike distortions occurring over 50% of the panel during the first minute of the test. Within 5 minutes, the curling/sagging in the vicinity of the flame covered 5 to 10% of the surface area. During the high burn phase, the curling of the sheet was siginifcant over the whole panel, with sections curling as much as two feet away from the flame in some locations. This sample passed all of the acceptance criteria as defined by the test.

### Example 24

Sheet samples of polymer C having a thickness of 0.060 inches (1.5 mm) were tested according to NFPA 286 using the walls only configuration and the rigid mounting technique. Even with the rigid mounting, the panels showed curling beginning to occur within the first couple of minutes. After 5 minutes, the panel showed significant curling away from the flame over about 30% of the panel surface. During the high burn phase, this significant curling increased to cover 50% of the panel. The test sample passed all of the acceptance criteria as defined by the test.

### Example 25

Sheet samples of polymer C having a thickness of 0.354 inches (9 mm) were tested according to NFPA 286 using the walls only configuration and the perimeter mounting technique. This sample showed no visible signs of distortion/sagging during the test, thereby allowing the flame to ignite the sheet. As a result, the test sample did not meet the acceptance criteria as defined by the test.

### Example 26

Sheet samples of polymer D having a thickness of 0.236 inches (6 mm) were tested according to NFPA 286 using the tested in a walls only configuration and the rigid mounting technique. The panels showed no noticeable sagging curling (i.e. <5% surface area of the panel) during the low watt burn phase. During the high watt phase, the sheet did begin to deform significantly over about 50 to 75% of the sheet area (in some places the sheet moved a foot or more away from the flame). The sheet had already ignited at this point and flame was beginning to spread. The test sample did not meet the acceptance criteria as defined by the test.

### Example 27

Sheet samples of polymer D having a thickness of 0.118 inches (3.2 mm) were tested according to NFPA 286 using the tested in a walls only configuration and the perimeter mounting technique. At the end of the low watt burn phase, the panel showed significant curling/sagging away from the flame over about 20% of the panel area (curling deflection was 6 inches to a foot in some places). During the high watt burn, the curling occurred over about 80% of the panel. The test sample did not meet the acceptance criteria as defined by the test because the panel ignited and the flames began to propagate.

### Example 28

Sheet samples of polymer D having a thickness of 0.060 inches (1.5 mm) were tested according to NFPA 286 using the tested in a walls only configuration and the perimeter mounting technique. At the end of the 5 minute low burn phase, the panel showed distortion away from the flame over about 30% of the sheet area (deflections of 6 inches to a foot away from the flame occurred in some spots). During the high burn phase, this sag/curl area increased to 80% coverage. Panel, however, ignited and did not meet the acceptance criteria as defined by the test.

The results from Examples 1-28 are summarized in Table 3. In Table 3, the “Mount” column indicates perimeter mounting (P) or rigid mounting (R) as described above. The column labeled “P/F” indicates if the sheet passed (P) or failed (F) the NFPA 286 acceptance criteria. The Tg values for polymers F and G are estimates. The calculated minimum spacing between attachment points, Lc, is given in inches. The Tg values for the blends of Examples 13-16 were calculated using the Fox equation:

$$\frac{1}{{T}_{g}} = \frac{{W}_{1}}{{T}_{g 1}} + \frac{{W}_{2}}{{T}_{g 2}}$$

wherein:
T_{g} is the glass transition temperature in ° C. of the blend;
W₁, W₂ are the weight fractions of the polymer 1 and polymer 2, respectively;
T_{g1}, T_{g2} are the glass transition temperature in degrees Kelvin of polymer 1 and polymer 2, respectively
   The effect of crystallization and heat release capacity on the fire performance of polyester sheet is demonstrated by Examples 1-7. Example 1 fails NFPA 268 because the sheet crystallizes significantly during the initial stages of the fire and the crystallinity subsequently inhibits the material from curling or peeling away from the flame source before it ignites. Examples 2-4 pass NFPA 268 because they exhibit slow crystallization rates and relatively low heat release capacity. Examples 5-7 fail NFPA 268 because the materials have high heat release capacities and consequently ignite during the early stages of the fire. In summary, compositions with crystallization half times greater than 2 minutes and heat release capacities less than about 400 J/gK pass the NFPA 268.

The effect of mounting technique is demonstrated by Examples 9 and 10. Specifically, as the degree of attachment for the sheet to the structure increases from perimeter mounting to rigid mounting the material fails NFPA 268 because the rigid mounting prevents the sheet from sagging or peeling away from the flame before it ignites.

The effect of the relationship between the spacing between fasteners and Tg is demonstrated by examples 4, 13-15, and 11. As Tg increases the samples begin to fail NFPA 268 because the samples cannot curl or peel away from the flame source before they ignite.

TABLE 3

| | | | | | Heat | | | | | |
|---|---|---|---|---|---|---|---|---|---|---|
| | | | | | Release | Cryst. ½ | | | Calc. | |
| | | Thickness | Walls/ | Mount | Capacity | time (min) | Char | Tg | Lc | |
| Ex. | Polymer | (mils) | Ceiling | (spacing) | (l/g K) | Glass/Melt | (wt %) | ° C. | (inches) | P/F |
| 1 | A | 236 | W | P (24″) | 206 | 3.1/3.5 | 10 | 80 (170) | >400 | F |
| | | | | L = 27″ | | | | | | |
| 2 | B | 236 | W | P (24″) | 243 | ND/8 | 8 | 78 | 14 | P |
| | | | | L = 27″ | | | | | | |
| 3 | C | 236 | W | P (24″) | 330 | 1610/2500 | 5 | 80 | 15 | P |
| | | | | L = 27″ | | | | | | |
| 4 | D | 236 | W | P (24″) | 451 | 31.5/30 | 2 | 86 | 18 | P |
| | | | | L = 27″ | | | | | | |
| 5 | E | 236 | W | P (24″) | 512 | 2.8/3 | 1 | 91 (170) | >400 | F |
| | | | | L = 27″ | | | | | | |
| 6 | F | 236 | W | P (24″) | 563 | 5.2/5 | 0 | 88 (170) | >400 | F |
| | | | | L = 27″ | | | | | | |
| 7 | G | 236 | W | P (24″) | 563 | 18.7/39 | 0 | 86 | 18 | F |
| | | | | L = 27″ | | | | | | |
| 8 | C | 80 | W | P (24″) | 330 | 1610/2500 | 5 | 80 | 2 | P |
| | | | | L = 27″ | | | | | | |
| 9 | C | 236 | W/C | P (24″) | 330 | 1610/2500 | 5 | 80 | 15 | P |
| | | | | L = 27″ | | | | | | |
| 10 | C | 236 | W/C | R (16″) | 330 | 1610/2500 | 5 | 80 | 15 | F |
| | | | | L = 15.8″ | | | | | | |
| 11 | H | 236 | W/C | P (24″) | 362 | >1600 (est) | 28 | 150 | 174 | F |
| | | | | L = 27″ | | | | | | |
| 12 | I | 236 | W/C | P (24″) | 753 | >1600 (est) | 0 | 100 | 27 | F |
| | | | | L = 27″ | | | | | | |
| 13 | 70:30 | 236 | W/C | P (24″) | 424 | 74/ND | 10 | 100 | 27 | F |
| | D:H | | | L = 27″ | | | | | | |
| 14 | 50:50 | 236 | W | P (24″) | 406 | 300/ND | 15 | 110 | 38 | F |
| | D:H | | | L = 27″ | | | | | | |
| 15 | 30:70 | 236 | W | P (24″) | 389 | 850/ND | 20 | 125 | 65 | F |
| | D:H | | | L = 27″ | | | | | | |
| 16 | 50:50 | 236 | W | P (24″) | 620.3 | 38/ND | | 103 | 30 | F |
| | J:H | | | L = 27″ | | | | | | |
| 17 | C + RDP | 236 | W | P (24″) | 330 | — | 13 | 70 | 11 | P |
| | | | | L = 27″ | | | | | | |
| 18 | B | 236 | W | R (16″) | 243 | ND/8 | 8 | 80 | 15 | P |
| | | | | L = 15.8″ | | | | | | |
| 19 | B | 60 | W | R (16″) | 243 | ND/8 | 8 | 80 | 1 | P |
| | | | | L = 15.8″ | | | | | | |
| 20 | B | 60 | W | P (24″) | 243 | ND/8 | 8 | 80 | 1 | P |
| | | | | L = 27″ | | | | | | |
| 21 | C | 236 | W | R (16″) | 330 | 1610/2500 | 5 | 80 | 15 | P |
| | | | | L = 15.8″ | | | | | | |
| 22 | C | 60 | W | P (24″) | 330 | 1610/2500 | 5 | 80 | 1 | P |
| | | | | L = 27″ | | | | | | |
| 23 | C | 150 | W | P (24″) | 330 | 1610/2500 | 5 | 80 | 4 | P |
| | | | | L = 27″ | | | | | | |
| 24 | C | 60 | W | R (16″) | 330 | 1610/2500 | 5 | 80 | 1 | P |
| | | | | L = 15.8″ | | | | | | |
| 25 | C | 354 | W | P (24″) | 330 | 1610/2500 | 5 | 80 | 53 | F |
| | | | | L = 27″ | | | | | | |
| 26 | D | 236 | W | R (16″) | 451 | 31.5/30 | 2 | 86 | 18 | F |
| | | | | L = 15.8″ | | | | | | |
| 27 | D | 118 | W | P (24″) | 451 | 31.5/30 | 2 | 86 | 2 | F |
| | | | | L = 27″ | | | | | | |
| 28 | D | 60 | W | P (24″) | 451 | 31.5/30 | 2 | 86 | 2 | F |
| | | | | L = 27″ | | | | | | |

### Example 29

Modeling of the Relationship between Attachment Spacing, Sheet Thickness and Tg—Yet another embodiment of this invention is the relationship between sheet thickness and mounting technique which is modeled in this experiment. Curling, peeling, shrinking, falling away, and sagging are a function of material parameters such as modulus and glass transition temperature Tg and experimental parameters such time and temperature. As the material thickness increases, the time and temperature required for the material to flow and sag increases. This is best illustrated in following example. The material can be attached by any method by one skilled in the art, which includes but is not limited to screws, bolts, nails, rivets, and hangers. In addition, an adhesive can be used to adhere the material to the walls. The adhesive selected should allow the material to flow and sag. A hot melt adhesive is an example of an adhesive that would allow the material to flow and sag away from the wall and away from the flame. Alternatively, a thermosetting adhesive would not be a good choice and materials with significant heat release capacities could also be detrimental to the testing,

This prophetic example illustrates the effect of the following variables on the burn characteristics of the sheet: sheet thickness, polymer glass transition temperature Tg, and spacing distance (in meters), L, between fasteners along the horizontal axis. Similar effects are expected for the vertical spacing. As the spacing between support points increases, the sheet is able to more readily sag away from the flame and thus not burn significantly. This example is based on computational modeling of the heat transfer and sag in the sheet during the test.

Simulations were performed using Maple 10 symbolic software (Waterloo Maple Inc.) and are aimed more at the sheet just outside of the flame and how it heats up and deforms during the 900 seconds of the test. The heating of the sheet was modeled using a “lumped capacitance” type model wherein conductivity effects are neglected (see, for example, “Handbook of Applied Thermal Design” by E. C. Guyer (McGraw Hill, New York, 1989) or any standard heat transfer text). The entire sheet is thus assumed to heatup uniformily across the thickness—a reasonable assumption given that the heating mechanism is natural convection. Some radiation heating effects are also present but the plastic sheet is semi-transparent to these wavelengths, and thus absorbs the heat fairly evenly across the thickness (further supporting a lumped capacitance approach). The model for the sheet temperature T(t) as a function of time is
T(t)=Te+(To−Te)exp(−ht/ρCₚδ)
where h is the convection coefficient in units of Watts/m²-C, Te is the (hot) air temperature, To is the initial sheet temperature (assumed to be 25° C.), p is the density, Cp is the heat capacity, and δ is the thickness. The value for h was assumed to be 20 W/m²-C which is typical of natural convection to/from a vertical flat wall. The polyester has an average density of 1100 kg/m³, and a Cp of 2000 W/kg-C. The thickness δ is preferably in consistent units of “meters”, however it is referred to in units of “mils” to remain consistent with the industry terminology and to keep the calculations less unwieldy.

The air temperature Te was based on experimental data from previous tests. It was found experimentally that the temperature in the vicinity of the wall is approximately 100° C. during the first 5 minutes of the test and about 300° C. thereafter (temperatures in the immediate vicinity of the flame will be much higher, but sag and curling depend on the sheet temperature away from the flame as well). This change corresponds with the changeover from the lower burner setting to the higher burner setting and is a result of the increased air heating in the room. If extensive burning of the sheet occurs, then additional heat is released, thereby driving the air temperature up even higher. However, for this model, it is assumed that significant burning and energy release has not yet occurred.

The variation in Te from 100 to 300° C. is introduced into the model via a Heaviside step function H(t). In other words the temperature is 100° C. up to a time of 300 seconds (5 minutes) and then mathematically jumps to 300° C. for the rest of the test. This is represented as
Te=100+200*H(t−300)
where the total test duration is 900 seconds.

Although this model gives the temperature as a function of time and temperature, it does not address whether or not the sheet will sag. To determine this, it is assumed that the sheet can be modeled as a cantilever beam hanging under its own weight. It is assumed that the supports immediately over the flame are broken/burnt, and that a length of sheet equal to the horizontal spacing between attachment points, L, is hanging freely. The “cantilever side corresponds with the supports that are still in place. Obviously the larger the spacing between attachment points, the more weight applied and the more likely the sheet will sag down and away from the flame.

The equations for beam deflection can be obtained from any appropriate mechanics text, such as, for example, Roark's Formulas for Stress and Strain, by W. Young, McGraw Hill, 1989, p 102. The beam in this model has a length L_{c}, a width Y, and a load per unit length w, where w equals ρgYδ, and g is the gravitational constant (9.8 m/s²). This term w represents the force exhibited per unit length on the beam, due to the beam's own weight. For the experimental studies, Y is 2.24 meters and represents the distance from floor to ceiling. Note for this analysis that the beam is effectively horizontal to the floor with the “bending” occurring in the width or Y dimension and the length being equal to the spacing between supports Lc.

Maximum deflection and bar rotation occurs at the end of the beam (near the flame). It is assumed that the beam has moved out of the flame when the end rotation angle φ (in units of radians) exceeds about π/4 radians (45 degrees) referenced to the horizontal. Note that these equations are strictly accurate only for small deflections/rotations; however numerical accuracy at this point is not important as long as the deflection is large and it is known at what point deflection occurs. The value of π/4 radians represents an arbitrary, but sufficientaly large rotation for our purposes. The equation for end deflection angle is thus

$$ϕ = \frac{{wL}_{c}^{3}}{6 EI}$$

where E is the modulus (which is a function of temperature), and I is the area moment of interia of the cross section which equals δY²/12. This equation gives the angle of rotation as a function of the spacing between attachment points, L_{c}, the thickness, and the modulus. As mentioned previously, it is assumed there is excessive sag when φ exceeds about π/4 radians. For a given thickness of sheet, this value is used and solved for the required support spacing as a function of modulus.

The above describes temperature as a function of time of the sheet, as well as deflection as a function of modulus. The last item is to relate modulus and temperature whereby all of these relations can be combined. For an amorphous copolyester, the modulus is typically about 10⁹ Pa at Tg (80° C.), and decreases to about 10⁶ Pa at 120° C., with a further decrease to 10³ or less at 200° C. Further heating causes the polymer to be liquid-like and modulus eventually becomes almost meaningless. Although there are a few “plateaus” in this modulus versus temperature data, it can be fairly accurately modeled with the following Arrhenius type relationship

$$E = 4.25 \times {10}^{- 16} exp ( \frac{19892}{( T + 273 )} )$$

where T is in degrees Celsius. Other polyesters and miscible polyester blends will have similar modulus versus temperature behavior above Tg (as will most glassy polymers in general), however, their curves will be shifted to account for variations in Tg. To account for Tg variations in this model, the above equation is modified to be

$$E = 4.25 \times {10}^{- 16} exp ( \frac{19892}{( T + ( 80 - Tg ) + 273 )} )$$

The extra “80-Tg” term shifts the curve to higher temperatures as Tg increases and provides a good approximation to a wide range of glassy polyesters and polymers.

In the case of crystalline polymers, or polymers that rapidly crystallize as denoted by having a crystallization half time of less than about 10 minutes, the crystalline network that forms acts to make the sheet more rigid. For these samples, it is more appropriate to use the melting temperature in place of the Tg above. Crystalline polymers will typically have melting points of 170C and up depending on the degree of “perfection” in the crystal structure. We will assume a value of 170C in the model for any samples with a crsytallization half-time <10 minutes. Obviously, crystal formation will act to keep the sheet in the flame longer, and is expected to increase the chance of sheet combustion.

Next, the equations for temperature and modulus are substituted into the equation for deflection angle and arrive at an equation (after some algebraic manipulation) for sag angle as a function of time, sheet thickness, spacing between supports Lc, and glass transition temperature Tg. This equation is as follows:

$$Φ = \frac{8.9 \times {10}^{18} {L}_{c}^{3}}{exp [ \frac{19892}{\begin{matrix}- 75 exp ( \frac{- 1000 t}{2921 δ} ) + 200 H ( t - 300 ) - \\ 200 H ( t - 300 ) exp ( \frac{- 1000 ( t - 300 )}{1397 δ} ) - Tg + 453\end{matrix}} ]}$$

One question is whether or not the sheet will sufficiently sag away from the flame within the test duration (900 seconds). By plugging in t=900s and setting the sag angle to 0.17 radians, it is possible to determine the minimum critical spacing between attachment points, L_{c}, to induce sag, as a function of the sheet thickness and glass transition temperature. After further algebraic manipulation and solving for Lc, one arrives at

$${L}_{C} = 2.69 \times {{10}^{- 7} [ exp ( \frac{- 19892}{\begin{matrix}75 exp ( - 308 / δ ) + 200 exp \\ ( - 205 / δ ) + Tg - 653\end{matrix}} ) ]}^{1 / 3}$$

Results are compiled in Table 4 for different values of sheet thickness and Tg. Note that in the above equation sheet thickness is in mils, and the spacing Lc is in meters. In Table 4, however, Lc has been converted to inches for comparison with the experimental data.

The predicted value of Lc is also compiled in Table 3 for Examples 1-28. As stated above, for the case of rapidly crystallizing materials (i.e. crystallization half times of <10 minutes), the Tg is replaced in the model with an approximate melt temperature of 170° C. For a better understanding of the results, compare the predicted Lc with the experimental data of Example 21, 23, and 25 of Table 3 which represents a series of sheet samples of constant Tg but increasing thickness (150 to 354 mils). The Tg of the polymer is 80° C. and the sheet is mounted at 24″ integrals. The critical length Lc increases as a function of sheet thickness from 5 inches (150 mil sheet) to 53 inches (354 mil sheet). In the case of the 354 mil sheet of Example 25, this is greater than the 24″ mount spacing used during the test so the sheet is predicted to fail (in agreement with experiment). Observation of this burn test showed that this thick sheet was simply too rigid and did not soften and deform enough to move away from the flame. In contrast, Examples 21 and 23 have predicted Lc values that are less than the 24″ mounting spacing so they are predicted to pass the burn test. This was also in agreement with the experiment as visual inspection showed significant curling and deformation that prevented the sheet from fully igniting.

As another example, a 236 mil sheet having a Tg of 125° C. (e.g. Example 15) would require a larger attachment point spacing, Lc, of at least about 65 inches. The higher Tg of the sheet causes it to maintain stiffness longer, and thus is more prone to burning (the sheet in Example 15 failed the burn test). Hence, more widely spaced supports are needed to enhance sagging. With the exception of Tg, the sheet in Example 15 has similar properties to Example 3 yet the latter passed the burn test as it was more able to curl and sag away from the flame.

Examples 4, 6, 7, 12, 13, 16, and 26-28 failed because their heat release capacity was too high causing them to readily ignite. Most of these films did show significant curling in agreement with the Lc predictions, but their flammability was simply too high to prevent combustion.

Comparison of Examples 9, 10, and 21 illustrates the effects of mounting method on the sheet. All three were made from PETG (polymer C), having a Tg of 80C, and all three were of the same thickness. Examples 9 and 10 were mounted with panels on both the walls and ceilings whereas samples 21 was walls only. Similarly, Examples 10 and 21 involved more rigid mounting at 16″ intervals instead of the 24″ intervals for Example 9. The predicted value of Lc for this sheet is 15″ which indicates that all should pass the burn test although the 16″ mounts are expected to be “borderline”. This is, in fact, in agreement with experimental results. Example 9 and 21 did pass in agreement with the data, however Example 10 failed because the ceiling panel ignited and increased flame spread. Without that ceiling panel however, the rigid mount will just pass (e.g. Example 21), Thus, these samples illustrate how subtle variations in mounting method can alter the pass/fail results of the burn test when the mount spacing is close to Lc.

Another observation is that the critical spacing gets smaller as the sheet gets thinner. Thus for a material that is very thin (like a wallpaper), the attachment point spacing can be very small as the film will rapidly heat and sag away. For example, a 60 mil sheet with a Tg of 80° C., will require a attachment point spacing, Lc, of only 1 inch or greater to allow adequate sagging. Furthermore, if the panel or sheet is mounted with offsets so that it is sufficiently away from the wall to allow rapid heat transfer to occur on BOTH sides of the panel, then the effective thickness of the wallcovering d should be replaced with the half-thickness. For example, if a sheet that is 100 mils thick is mounted to the wall with offsets, the value for d would be 50 mils, not 100 mils. This changes reflects the fact that the sheet will heat much more quickly (and thus sag more quickly), than a similar sheet attached directly to the wall.

TABLE 4
Minimum Attachment Point Spacing Lc (Inches) as a Function of
Sheet Thickness and Tg

| Sheet | | | | | |
|---|---|---|---|---|---|
| Thickness | Tg = | Tg = | Tg = | | |
| (mils) | 60° C. | 80° C. | 100° C. | Tg = 120° C. | Tg = 140° C. |
| 60 | 1 | 1 | 2 | 3 | 5 |
| 80 | 1 | 2 | 3 | 4 | 7 |
| 118 | 2 | 3 | 4 | 7 | 13 |
| 160 | 3 | 5 | 9 | 16 | 29 |
| 200 | 5 | 9 | 16 | 31 | 62 |
| 240 | 9 | 15 | 29 | 58 | 124 |
| 300 | 16 | 31 | 62 | 134 | 313 |
| 360 | 28 | 56 | 120 | 277 | 700 |

### Example 30

Application of a High Shrink Film to Sheet for Improved Separation. In this prophetic example, a copolyester shrink film is laminated to a PETG polyester containing 100 mole % terephthalic acid, 31 mole % 1,4-cyclohexanedimethanol, and 69 mole % ethylene glycol sheet to enhance distortion in the burn test. The copolyester shrink film is made using, for example, Eastman Embrace™ copolyester resin and is obtained by stretching the film about 5× on a tenter and/or a drafter to produce orientation in one or more directions. The orientation is “locked in” to the film by rapidly cooling and shrinkage is activated by reheating the film in the vicinity of 70° C. or hotter. Typical commercial shrink film made from Embrace™ is stretched on a tenter frame, has a nominal thickness of 2 mils, and has about 75% shrinkage recovery at 100° C.

This shrink film is laminated to one side of the PETG heavy gauge sheet as it is being made on the extrusion line. Residual heat from the PETG sheet will induce adhesion to the shrink film, but care must be taken to keep the temperature low enough so as not to induce premature shrinkage. The PETG sheet is assumed to be a nominal 118 mils before lamination. Because the copolyester shrink film is clear, and compatible with the PETG, there are no problems with haze, color or recycle/regrind compatibility. Nevertheless, the shrink film could be used to apply a thin layer of UV protection, color, gloss etc. if so desired.

Copolyester shrink film has a typical shrinkage stress of about 9 MPa (1300 psi). This is the stress exerted by the film as it undergoes shrinkage. For a 2 mil film, this constitutes a force of 2.6 lbs per lineal inch of width. Since the shrink film is laminated on one side of the PETG sheet, this shrinkage force will act in a manner to cause the sheet to buckle and curl towards the shrink film side of the sheet (i.e. concave curvature on shrink film side). For a 4 foot (48 inches) wide sheet panel, this converts to 124 lbs being exerted on the sheet by a 2 mil film which is a considerable force.

It is preferred to mount the shrink film on the side away from the underlying support wall, so as to cause the curling away from the wall (and flame). However, lamination to the “inside surface” will also work. In fact, the latter method is preferred if the overall structure is to be glued to a wall surface, as the high shrinkage will help to more readily break the glue bond, thereby allowing the sheet to fall away and out of the flame.

The shrinkage direction of the film can be aligned either horizontally or vertically in the case of uniaxial film, or in both directions in the case of biaxially oriented shrink film. In this prophetic example, however, it is mounted such that the shrink direction is in the horizontal direction on the wall, since this would cause the most rapid curling away from the heat source.

### Example 31

Oriented PETG Sheet—This prophetic example is similar to Example 30, except that the whole sheet structure is now oriented. Most of the polymers used for sheeting will exhibit high shrinkage if oriented properly, the problem being that orientation of a sheet causes a thickness reduction that can make the sheet unacceptably thin. Nevertheless, for some applications, the increase in stiffness from orientation can offset the loss of stiffness from thickness reduction, with the added benefit of better fire resistance.

In this example, heavy gauge sheet made from a PETG polyester containing 100 mole % terephthalic acid, 31 mole % 1,4-cyclohexanedimethanol, and 69 mole % ethylene glycol is cast and/or polished using traditional means described above. Initial casting thickness is 400 mils, After casting, the sheet is then uniaxially oriented using a compression assisted drafting unit. The drafting process is similar to a normal MDO drafter used for film, but the added compression at the rolls allows for reduced stretch ratios without the formation of undesirable gauge bands. The sheet in this example is stretched approximately 3× at 90° C. by this method and then cut into appropriate sized sheets. The final sheet thickness is 133 mils (=1/3*400).

Shrinkage stresses for this sheet are comparable to the Embrace shrink film in the previous example, except now the whole thickness of the sheet will shrink (not just the laminate layer), thus significantly increasing the total force. Shrink forces of the order of 100 to 200 lbs per lineal inch of sheet can be expected when the sheet reaches a temperature of about 80 to 90° C. This high force will cause rapid shrinkage away from flame, and will cause tearout and/or breakage of the sheet near the mounting points. Thus, in the very early stages of ignition, the sheet will shrink a significant distance away from the flame, thus preventing the possibility of flame spread to the walls.

### Example 32

Oriented PET Sheet—This prophetic example is similar to Example 31, except that poly(ethylene) terephthalate (PET) is used instead of PETG. Because of its tendency to crystallize, the initial cast sheet is only 300 mils thick. The PET sheet is oriented approximately 3×1 using a tenter frame at 90° C. No heatsetting is performed as we want to maximize shrinkage. Because PET will crystallize when stretched, it will lose much of its ability to shrink at lower temperatures. A typical stretched PET will shrink about 20 to 30% below 100° C. However, it will still shrink even more, albeit at much higher temperatures, when the constraining crystals begin to melt. In the temperature range from about 150 to 250° C., this higher shrinkage will occur, and with considerable shrink force. Although the total shrinkage is reduced (and spread out over a broader temperature range), it is still enough to cause considerable warping and curling of the sheet, and thus move the sheet away from any flame.

### Example 33

PETG/Fiber Fabric Laminate—In this prophetic example, unoriented PETG sheet using a polyester containing 100 mole % terephthalic acid, 31 mole % 1,4-cyclohexanedimethanol, and 69 mole % ethylene glycol is made by standard means, and is laminated together with a highly oriented polyester fiber fabric. The fabric is woven into a decorative design, using highly oriented, non-heatset fibers with high shrinkage capacity. For this example, the fibers are made from a PCTG polyester containing 100 mole % terephthalic acid, 62 mole % 1,4-cyclohexanedimethanol, and 38 mole % ethylene glycol, and are melt spun and then drafted to produce highly oriented fiber/yarn. The heatsetting step is not applied since we want to maintain shrinkage. Fibers made from a PCTG polyester by this process will have very high shrinkage (approximately 70%) with the shrinkage beginning around 80 to 100° C. The higher shrink range of a PCTG polyester relative to a PETG polyester is because of the difference in Tg (86° C. for PCTG versus 80° C. for PETG).

This fabric is weaved into a decorative pattern, and then laminated between two sheets of PETG sheet. For this example, the sheets are of different thicknesses as we want the fabric to be “off-center” so as to accentuate warping in the flame. Thus we use a 100 mil sheet on one side, and a 20 mil sheet on the other, with the fabric in between, to produce a 120 mil final product. The fabric is applied using standard lamination techniques, preferably as part of the 100 mil sheet extrusion process. Care must be taken to keep temperatures low so as not to cause the PCTG fiber to shrink, but the PCTG's higher Tg and shrink window will provide a wider lamination window.

The final sheet has aesthetic and decorative properties, but is also capable of significant shrinkage and curling when near a flame. Actual shrinkage directions will vary depending on the weave of the fabric, but will typically be biaxial in nature. The resulting curl will move the sheet out of the flame and will stop flame spread.

### Example 34

Use of a High Temperature Foaming Additive—In this prophetic example, a chemical blowing agent with a high activation temperature is introduced into a layer of the sheet. The activation temperature is above the normal processing temperature so foaming does not occur during the sheet formation process. Instead, it is designed such that foaming will not occur until the sheet is exposed to a flame source, thereby liberating nitrogen or carbon dioxide, while simultaneously weakening the sheet so as to help it more rapidly fall away from the wall.

The final structure is an A/B/A laminate consisting of standard PETG (as described in example 33) sheet of 110 mils (the B layer), with a 5 mil layer of PETG plus foaming agent on each side (the A layers). The A layer is made by a calendering process since temperatures used are lower than extrusion and are less likely to activate the foaming agent. The A layer consists of PETG with about 1 wt % of an azodicarbonamide blowing agent (e.g. Celogen HT-550) which does not release gas until temperatures of about 230 to 370° C. Actual release temperature can be controlled or tailored as needed by adding activators and/or dispersing it in appropriate carrier resins. The calendering temperature is about 170 to 190° C. The sheet produced is then laminated to the bulk PETG sheet (B-layer) to form the final structure.

Upon exposure to flame, the outside A surface will foam first releasing nitrogen which will help to quench the burn. As the inside surface gets hotter, it will start to foam causing it to “break away” from any supports or adhesives that might be holding it in place.

Foaming agent could be incorporated throughout the whole sheet via extrusion compounding (although the sheet will be considerably more hazy), but care must be taken to keep the extrusion temperatures very low.

We claim:

1. A method for reducing flame spread, comprising: attaching at least one interior finish to a ceiling, one or more walls, or combination thereof, of a room, said interior finish comprising a film, sheet, or profile comprising at least 80 weight percent, based on the total weight of said interior finish, of a polymer composition having a crystallization half-time of at least 5 minutes, a heat release capacity of about 400 J/g ° K or less, and a char generation of 20% or less, and having a total area of at least 10% of the total area of said ceilings and walls of said room; wherein said interior finish partially or completely detaches from said walls or ceiling after exposure for 5 minutes or less to the heat of a 40 kW flame as set forth by National Fire Protection Agency Standard NFPA 286.

2. The method according to claim 1 wherein said interior finish detaches by sagging, curling, peeling, falling away, shrinking, or foaming.

3. The method according to claim 1 wherein said detachment comprises all or a portion of said interior finish moving out of the plane of said ceiling or walls.

4. The method according to claim 1 wherein said interior finish comprises a sheet, film, fiber, fabric, profile, or prefabricated panel.

5. The method according to claim 1 wherein said polymer composition comprises at least one polymer selected from the group consisting of polyesters, polyamide, polycarbonates, polypropylenes, polyethylenes, polyacrylates, cellulosics, poly(methylmethacrylates), copolymers thereof, and combinations thereof.

6. The method according to claim 1 wherein interior finish comprises a heat shrinkable film, sheet, fiber, or fabric which exhibits at least 20% shrinkage after 5 minutes exposure to water or air at 100° C.

7. The method according to claim 1 further comprising attaching said interior finish with an 2 or more fasteners which soften or melt at a temperature of about 70° C. to about 250° C.

8. The method according to claim 7 wherein said fasteners comprise a nail, screw, rivet, bolt, clasp, bracket, or combination thereof.

9. The method according to claim 8 wherein said interior finish detaches by softening or melting of said fasteners.

10. The method according to claim 9 wherein said fastener comprises a metal, metal alloy, polyolefin, polyester, polyamide, styrenic, cellulosic, combination thereof, or copolymer thereof.

11. A method for reducing flame spread, comprising: attaching at least one interior finish to a ceiling, one or more walls, or combination thereof, of a room with 2 or more fasteners, said interior finish having a total area of at least 10% of the total area of said ceiling and walls of said room and comprising a film, sheet, or profile comprising at least 80 weight percent, based on the total weight of said interior finish, of a polymer composition having a crystallization half-time of at least 5 minutes, a heat release capacity of about 400 J/g ° K or less, and a char generation of 20% or less; and said fasteners being separated by an average spacing, L, that is equal to or greater than a minimum distance, Lc, wherein L and Lc are defined by the following formulas:
$$L = \sqrt{\frac{Area}{N - 2 \sqrt{N} + 1}}$$
wherein
L is said average spacing in meters,
N is the number of said fasteners, and
Area is the area of said interior finish in square meters, and
$${L}_{C} = 2.69 \times {{10}^{- 7} [ exp ( \frac{- 19892}{\begin{matrix}75 exp ( - 308 / δ ) + 200 exp \\ ( - 205 / δ ) + Tg - 653\end{matrix}} ) ]}^{1 / 3}$$
wherein
Lc is said minimum distance in meters,
δ is the thickness in mils of said interior finish, and
Tg is the glass transition temperature of said polymer composition in ° C.

12. The method according to claim 11 wherein said interior finish further comprises a fiber, fabric, or prefabricated panel.

13. The method according to claim 11 wherein said interior finish comprises 1 to 7 layers.

14. The method according to claim 13 wherein said interior finish contains 2 to 4 different polymers.

15. The method according to claim 11 wherein said sheet, film, or profile has at least 20% shrinkage after 5 minutes exposure to water or air at 100° C.

16. The method according to claim 111 wherein said interior finish comprises at least 90 weight percent of said polymer composition.

17. The method according to claim 11 wherein said polymer composition comprises at least one polymer selected from the group consisting of polyesters, polyamides, polycarbonates, polypropylenes, polyethylenes, polyacrylates, poly(methylmethacrylates), cellulosics, copolymers thereof, and combinations thereof.

18. The method according to claim 11 wherein said polymer composition comprises at least one polyester comprising diacid residues, comprising at least 80 mole percent, based on the total moles of diacid residues, of the residues of one or more dicarboxylic acids selected from the group consisting of terephthalic acid, naphthalenedicarboxylic acid, 1,4-cyclohexanedicarboxylic acid, and isophthalic acid; and diol residues comprising about 10 to 100 mole percent, based on the total moles of diol residues, of the residues of one or more diols selected from the group consisting of 1,4-cyclohexanedimethanol; neopentyl glycol; 2,2,4,4-tetramethyl-1,3-cyclobutanediol, and ethylene glycol; and about 0 to 90 percent of the residues of one or more diols selected from the group consisting of diethylene glycol, 1,2-propanediol, 1,3-propanediol, 1,4-butanediol, 1,5-pentanediol, 1,6-hexanediol, 1,8-octanediol, 2,2,4-trimethyl-1,3-pentanediol, 1,3-cyclohexanedimethanol, bisphenol A, and polyalkylene glycol.

19. The method according to claim 18 wherein said diacid residues further comprise about 0 to 20 mole percent of the residues one or more dicarboxylic acids selected from the group consisting of fumaric, succinic, adipic, glutaric, azelaic, sebacic, resorcinol diacetic, diglycolic, 4,4′-oxybis(benzoic), biphenyldicarboxylic, 4,4′-methylenedibenzoic, trans-4,4′-stilbenedicarboxylic, and sulfoisophthalic acids.

20. The method according to claim 18 wherein said polyester further comprises the residues of one or more branching agents selected from the group consisting of trimellitic anhydride, pyromellitic dianhydride, glycerol, trimethylolpropane, and pentaerythritol.

21. The method according to claim 19 wherein said diacid residues comprise from about 60 to 100 mole percent of the residues of terephthalic acid and 0 to about 40 mole percent of the residues isophthalic acid.

22. The method according to claim 19 wherein said diacid residues comprise about 95 mole percent of the residues of terephthalic acid and about 5 mole percent of the residues of isophthalic acid.

23. The method according to claim 19 wherein said diacid residues comprise 100 mole percent of the residues terephthalic acid.

24. The method according to claim 19 wherein said diacid residues comprise 100 mole percent of the residues of terephthalic acid and said diol residues comprise about 10 to about 40 mole percent of the residues of 1,4-cyclohexanedimethanol and 60 to about 90 mole percent of the residues of ethylene glycol.

25. The method according to claim 19 wherein said diol residues comprise about 10 to about 99 mole percent of the residues of 1,4-cyclohexane-dimethanol, 0 to about 90 mole percent of the residues of ethylene glycol, and about 1 to about 25 mole percent of the residues of diethylene glycol.

26. The method according to claim 11 wherein said polymer composition has a crystallization half-time of at least 10 minutes.

27. The method according to claim 26 wherein said polymer composition has a crystallization half-time of at least 100 minutes.

28. The method according to claim 11 wherein said polymer composition has a heat release capacity of 350 J/g ° K or less.

29. The method according to claim 11 wherein said polymer composition has a char generation of 15% or less.

30. The method according to claim 11 wherein said at least one polymer has a char generation of 10% or less.

31. The method according to claim 11 wherein said interior finish has an total area of at least 20% of the total area of said ceiling and walls.

32. The method according to claim 11 wherein said interior finish has a total surface area of at least 40% of the total surface area of said room.

33. A method for reducing flame spread, comprising: attaching at least one interior finish to a ceiling, one or more walls, or combination thereof, of a room with 2 or more fasteners, wherein at least a portion of the inside surface of said interior finish is positioned at about 0.5 cm to about 20 cm from the surface of said ceiling or walls, said interior finish having a total area of at least 10% of the total area of said ceilings and walls and comprising a film, sheet, or profile comprising at least 80 weight percent, based on the total weight of said interior finish, of a polymer composition having a crystallization half-time of at least 5 minutes, a heat release capacity of 400 J/g ° K or less, and a char generation of 20% or less, and said fasteners being separated by an average spacing, L, that is equal to or greater than a minimum distance, Lc, wherein L and Lc are defined by the following formulas:
$$L = \sqrt{\frac{Area}{N - 2 \sqrt{N} + 1}}$$
wherein
L is said average spacing in meters,
N is the number of said fasteners, and
Area is the area of said interior finish in square meters; and
$${L}_{C} = 2.69 \times {{10}^{- 7} [ exp ( \frac{- 19892}{\begin{matrix}75 exp ( - 308 / δ ) + 200 exp \\ ( - 205 / δ ) + Tg - 653\end{matrix}} ) ]}^{1 / 3}$$
wherein
Lc is said minimum distance in meters,
δ is ½ of the thickness in mils of said interior finish, and
Tg is the glass transition temperature of said polymer composition in ° C.

34. The method according to claim 33 wherein said interior finish further comprises a fiber, fabric, or prefabricated panel.

35. The method according to claim 33 wherein said interior finish comprises 1 to 7 layers.

36. The method according to claim 33 wherein said polymer composition comprises at least one polymer selected from the group consisting of polyesters, polyamides, polycarbonates, polypropylenes, polyethylenes, polyacrylates, poly(methylmethacrylate)s, cellulosics, copolymers thereof, and combinations thereof.

37. The method according to claim 36 wherein said polymer composition comprises at least one polyester comprising diacid residues, comprising at least 80 mole percent, based on the total moles of diacid residues, of the residues of one or more dicarboxylic acids selected from the group consisting of terephthalic acid, naphthalenedicarboxylic acid, 1,4-cyclohexanedicarboxylic acid, and isophthalic acid; and diol residues comprising about 10 to 100 mole percent, based on the total moles of diol residues, of the residues of one or more diols selected from the group consisting of 1,4-cyclohexanedimethanol; neopentyl glycol; 2,2,4,4-tetramethyl-1,3-cyclobutanediol, and ethylene glycol; and about 0 to 90 percent of the residues of one or more diols selected from the group consisting of diethylene glycol, 1,2-propanediol, 1,3-propanediol, 1,4-butanediol, 1,5-pentanediol, 1,6-hexanediol, 1,8-octanediol, 2,2,4-trimethyl-1,3-pentanediol, 1,3-cyclohexanedimethanol, bisphenol A, and polyalkylene glycol.

38. The method according to claim 37 wherein said diacid residues comprise from about 60 to 100 mole percent of the residues of terephthalic acid and 0 to about 40 mole percent of the residues isophthalic acid.

39. The method according to claim 37 wherein said diacid residues comprise about 95 mole percent of the residues of terephthalic acid and about 5 mole percent of the residues of isophthalic acid.

40. The method according to claim 37 wherein said diacid residues comprise 100 mole percent of the residues terephthalic acid.

41. The method according to claim 37 wherein said diacid residues comprise 100 mole percent of the residues of terephthalic acid and said diol residues comprise about 10 to about 40 mole percent of the residues of 1,4-cyclohexanedimethanol and 60 to about 90 mole percent of the residues of ethylene glycol.

42. The method according to claim 37 wherein said diol residues comprise about 10 to about 99 mole percent of the residues of 1,4-cyclohexanedimethanol, 0 to about 90 mole percent of the residues of ethylene glycol, and about 1 to about 25 mole percent of the residues of diethylene glycol.

43. The method according to claim 33 wherein said polymer composition has a crystallization half-time of at least 10 minutes.

44. A method for reducing flame spread, comprising: attaching at least one interior finish to a ceiling, one or more walls, or combination thereof, of a room, with 2 or more fasteners which soften or melt at a temperature of about 70° C. to about 250° C., said interior finish comprising at least 50 weight percent of combustable substrate and having a total area of at least 10% of the total area of said walls and ceilings.

45. The method according to claim 44 wherein said interior finish detaches by softening or melting of said fasteners.

46. The method according to claim 44 wherein said interior finish detaches or partially detaches from said ceiling or wall by sagging, curling, peeling, falling away, or shrinking.

47. The method according to claim 44 wherein said detachment comprises all or a portion of said interior finish moving out of the plane of said ceiling or wall.

48. The method according to claim 44 wherein said interior finish comprises a sheet, film, fiber, fabric, profile, or prefabricated panel.

49. The method according to claim 44 wherein said combustable substrate comprises wood or at least one polymer.

50. The method according to claim 49 wherein said at least one polymer is selected from the group consisting of polyesters, polyamides, polycarbonates, polypropylenes, polyethylenes, polyacrylates, cellulosics, poly(methylmethacrylate)s, and copolymers thereof.

51. The method according to claim 50 wherein interior finish comprises a heat shrinkable film, sheet, fiber, or fabric which has at least 20% shrinkage after 5 minutes exposure to water or air at 100° C.

52. The method according to claim 45 wherein said fasteners comprise a nail, screw, rivet, bolt, clasp, bracket, adhesive, or combination thereof.

53. The method according to claim 45 wherein said adhesive or fastener comprises a metal, metal alloy, polyolefin, polyester, polyamide, styrenic, cellulosic, combination thereof, or copolymer thereof.

54. The method according to claim 44 wherein said interior finish has a total area of at least 20% of the total area of said walls and ceilings.

55. The method according to claim 44 wherein said interior finish has a total area of at least 40% of the total area of said walls and ceilings.
